(19) United States
(12) Patent Application Publication
(10) Pub. No.: US 2013/0179067 A1
(43) Pub. Date: Jul. 11, 2013

(54) Method, System and Computer Program Product for Optimizing Route Planning Digital Maps

(71) Applicants: Matthew J. Trowbridge, Charlottesville, VA (US); Randy L. Cogill, Charlottesville, VA (US)

(72) Inventors: Matthew J. Trowbridge, Charlottesville, VA (US); Randy L. Cogill, Charlottesville, VA (US)

(73) Assignee: University of Virginia Patent Foundation, d/b/a University of Virginia Licensing & Ventures Group, Charlottesville, VA (US)

(21) Appl. No.: 13/823,166

(22) PCT Filed: Sep. 28, 2011
(86) PCT No.: PCT/US11/53788

§ 371 Date: Mar. 14, 2013

Related U.S. Application Data
(60) Provisional application No. 61/387,753, filed on Sep. 29, 2010.
(60) Provisional application No. 61/387,703, filed on Sep. 29, 2010.

(51) Int. Cl. G01C 21/34

(52) U.S. Cl. CPC G01C 21/34
USPC 701/410; 701/533

(57) ABSTRACT

A system for digital network map development and maintenance. The system provides for optimizing digital network maps that serve as the reference basis for location-based systems such as, but not limited to, route guidance, multi-modal transportation system monitoring, location-based consumer applications, and vehicle fleet administration. The system provides the ability to develop and maintain digital route maps derived at least in part from data on the routes that drivers or users actually travel to update a digital map. For a route defined between two or more points, costs may be assigned to each road segment. As such, given a collection of route preferences, an algorithm is provided that is capable of generating an optimized route planning digital map by finding and assigning a set of costs to road segments in a way that is consistent with these preferences.

### CROSS-REFERENCE TO RELATED APPLICATIONS

The present application claims priority from U.S. Provisional Application Ser. No. 61/387,753, filed Sep. 29, 2010, entitled “Method, System and Computer Program Product for Learning Based Route Planning” and U.S. Provisional Application Ser. No. 61/387,703, filed Sep. 29, 2010, entitled “Method, System and Computer Program Product for Learning Based Route Planning;” the disclosures of which are hereby incorporated by reference herein in their entirety.

### FIELD OF THE INVENTION

The present invention relates to the field of digital network map development and maintenances. More specifically, the present invention relates to the field of optimizing digital network maps that serve as the reference basis for location-based systems such as, but not limited to, route guidance, multi-modal transportation system monitoring, location-based consumer applications, and vehicle fleet administration.

### BACKGROUND OF THE INVENTION

Over the past few years, route planning software such as Google Maps has become an integral part of trip planning for both commercial and private users. Increasingly powerful GPS-enabled mobile devices such as the Apple iPhone combined with improvements in wireless data services and integration with complementary data sources such as traffic status have also made access to customized point-of-use travel routing nearly ubiquitous. Despite these advancements, the performance of traditional routing systems remains sub-optimal; notably, for example, in contexts such as secondary street networks where data sources such as traffic counts from embedded sensors are not available and significant road segment features are not easily quantified (e.g. on-street parking patterns, efficacy of snow removal, presence of speed bumps). The inability of traditional routing systems to account for non-quantified network segment factors is particularly problematic for specialized users such as emergency responders, logistics companies, or military units that may not use standard metrics such as shortest time or distance as their metric for route optimization.

At the core, addressing the aforementioned deficiencies in performance and flexibility of traditional route planning systems requires a new approach to encoding information within digital network maps. Digital network maps, which include data regarding segments, nodes, and arc costs, are central to the functioning of route planning systems. However, traditional approaches to digital network map development, optimization, and maintenance have significant limitations.

Accordingly, an aspect of various embodiments of the invention described herein addresses numerous challenges to developing and maintaining optimized digital network maps including, but not limited thereto, the following: 1) heterogeneity of ‘optimal’ routes among specialized user groups or entities, 2) accounting for preferences without corresponding segment feature characteristics, 3) rapid identification of missing or broken network segments, 4) reflecting route preferences when limited or incomplete data segment characteristics is available, 5) automatic/data-driven determination of areas in network to ‘avoid’ and 6) response to rapid changes in network conditions or system-wide routing priorities.

### SUMMARY OF THE INVENTION

An aspect of an embodiment of the present invention relates to the field of digital network map development and maintenances. More specifically, an aspect of an embodiment of the present invention provides the ability to, among other things, develop and maintain digital route maps derived at least in part from data on the routes that drivers actually travel to update a digital map. The optimized digital map can be used for a route guidance system or method, whereby the routes generated by the system or method have the ability to, among other things, resemble the routes actually traveled by drivers or system users. For a route defined between two or more points, costs may be assigned to each road segment. If a driver or system user finds one route preferable to another, then the preferred route should have lower cost. As such, given a collection of route preferences, an aspect of an embodiment provides an algorithm that is capable of generating an optimized route planning digital map by finding and assigning a set of costs to road segments in a way that is consistent with these preferences.

An aspect of an embodiment of the present invention provides a system, method and computer program product for developing and maintaining a digital network map. For instance, an aspect of an embodiment of the present invention provides a system, method and computer program product for developing and/or maintaining a route planning digital map. Moreover, the route planning digital map may serve as the reference basis for location-based systems such as, but not limited to, route guidance, multi-modal transportation system monitoring, location-based consumer applications, and vehicle fleet administration

An aspect of various embodiments of the invention described herein provides a system, method and computer program product toward developing and maintaining optimized digital network maps including, but not limited thereto, the following: 1) heterogeneity of ‘optimal’ routes among specialized user groups or entities, 2) accounting for preferences without corresponding segment feature characteristics, 3) reflecting route preferences when limited or incomplete data segment characteristics is available, 4) rapid identification of missing or broken network segments, 5) automatic/data-driven determination of areas in network to ‘avoid,’ 6) response to rapid changes in network conditions or system-wide routing priorities and 7) reflecting significant factors that are not well represented, tracked or measured.

An aspect of an embodiment of the present invention provides a system for determining an optimum route planning digital map to be applied onto a first route planning digital map. The system may comprise: a) a memory component and b) a processor in communication with the memory component. The memory component may be operative to store: the first route planning digital map that may comprise a collection of nodes and arcs, wherein an arc is defined as a segment between a pair of nodes; and preferred route data, wherein the preferred route data may comprises a collection of arcs representing a collection of routes that an entity finds preferable with respect to some unquantified criterion. The memory component may be configured to: assign arc costs to the arc, wherein the assigned arc cost is determined by synthesizing the preferred route data together with a distribution over baseline arc costs; apply the assigned arc costs to the first route planning digital map to provide an optimized route planning digital map; and perform at least one of: i) storing the optimized route planning digital map for use, or ii) communicating the optimized route planning digital map for use with an output device or other processor based system.

An aspect of an embodiment of the present invention provides a computer implemented method for determining an optimum route planning digital map. The method may comprise: providing for receiving a first route planning digital map data, the first route planning digital map data comprises a collection of nodes and arcs, wherein an arc is defined as a segment between a pair of nodes, providing for receiving preferred route data, the preferred route data comprises a collection of arcs representing a collection of routes that an entity finds preferable with respect to some unquantified criterion; providing for assigning arc costs to the arc, wherein the assigned arc cost is determined by synthesizing the preferred route data together with a distribution over baseline arc costs; providing for applying the assigned arc costs to the first route planning digital map to provide an optimized route planning digital map; and providing for communicating the optimized planning digital map for storage or output.

An aspect of an embodiment of the present invention provides a computer program product comprising a non-transitory computer useable medium having a computer program logic for enabling a computer system for determining an optimum route planning digital map. The computer logic may comprise: receiving a first route planning digital map data, the first route planning digital map data comprises a collection of nodes and arcs, wherein an arc is defined as a segment between a pair of nodes; receiving preferred route data, the preferred route data comprises a collection of arcs representing a collection of routes that an entity finds preferable with respect to some unquantified criterion; assigning arc costs to the arc, wherein the assigned arc cost is determined by synthesizing the preferred route data together with a distribution over baseline arc costs; applying the assigned arc costs to the first route planning digital map to provide an optimized route planning digital map; and communicating the optimized planning digital map for storage or output. Moreover, the computer program product includes the computer logic that may be configured to perform any of the method steps provided and discussed in this disclosure.

An aspect of an embodiment of the present invention provides a server computer system. The server computer system may comprise: a memory component operative to receive and store data representing an optimized route planning digital map; and a processor in communication with the memory component configured to execute the optimized route planning digital map. Moreover, the optimized route planning digital map was produced (or can be produced) by the following steps: a) receiving a first route planning digital map data, wherein the first route planning digital map data comprises a collection of nodes and arcs, wherein an arc is defined as a segment between a pair of nodes, b) receiving preferred route data, wherein the preferred route data comprises a collection of arcs representing a collection of routes that an entity finds preferable with respect to some unquantified criterion, c) assigning arc costs to the arc, wherein the assigned arc cost is determined by synthesizing the preferred route data together with a distribution over baseline arc costs, and d) applying the assigned arc costs to the first route planning digital map to generate the optimized route planning digital map.

An aspect of an embodiment of the present invention provides a navigation system for use with, for example, a server computer system. The navigation system may comprise: a memory component operative to receive data from the server computer system, and store data representing an optimized route planning digital map; and a processor in communication with the memory component configured to execute the optimized route planning digital map. Further, the optimized route planning digital map was produced (or may be produced) by the following steps: a) receiving a first route planning digital map data, wherein the first route planning digital map data comprises a collection of nodes and arcs, wherein an arc is defined as a segment between a pair of nodes, b) receiving preferred route data, the preferred route data comprises a collection of arcs representing a collection of routes that an entity finds preferable with respect to some unquantified criterion; c) assigning arc costs to the arc, wherein the assigned arc cost is determined by synthesizing the preferred route data together with a distribution over baseline arc costs, and d) applying the assigned arc costs to the first route planning digital map to generate the optimized route planning digital map.

An aspect of various embodiments of the invention described herein provides a system, method and computer program product toward developing and maintaining optimized digital network maps including, but not limited thereto, for the following uses: providing point-to-point route planning; enabling quantitative analysis for city planners and transportation engineers; providing analysis of multi-stop routes such as for business delivery and supply-chain management; providing analysis of vehicle or pedestrian traffic to provide for tailored, customized or targeted marketing; providing streamlined integration into current route-planning software; increased navigational options to include terrain, safety, aesthetics or unmapped shortcuts across parking lots, down alleys or along footpaths; providing improved routing advice resulting from maps always being up-to-date; and providing easy integration into existing route planning software.

These and other objects, along with advantages and features of various aspects of embodiments of the invention disclosed herein, will be made more apparent from the description, drawings and claims that follow.

### BRIEF DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 provides a schematic block diagram of an embodiment of the digital map optimization system for determining an optimized route planning digital map.

FIG. 2A provides a flow chart illustrating an embodiment of the computer implemented method for determining and an optimized route planning digital map.

FIG. 2B provides a flowchart illustrating the method related to assigning the arc costs.

FIG. 3 is a schematic block diagram for a system or related method of an embodiment of the present invention in whole or in part.

FIG. 4 is a schematic block diagram for a system or related method of an embodiment of the present invention in whole or in part.

FIG. 5 is a schematic block diagram for a system or related method of an embodiment disclosed in FIG. 4 with the modification that additional aspects may be performed remotely on various servers.

FIG. 6 is a schematic block diagram for a system or related method of an embodiment of the present invention in whole or in part.

FIG. 7 is a schematic block diagram for a system or related method of an embodiment of the present invention in whole or in part.

FIG. 8 is a schematic block diagram for a system or related method of an embodiment of the present invention in whole or in part.

FIG. 9 provides a schematic diagram of a route planning digital map of an aspect of an embodiment of the present invention digital map optimization system and method.

FIG. 10 represents an optimized route planning map for San Francisco, Calif. generated by the use of an embodiment of the present invention digital map optimization system or method.

FIG. 11 represents an optimized route planning map for San Francisco, Calif. generated by the use of an embodiment of the present invention digital map optimization system or method, which provides a comparison to the generated conventional suggested route.

FIG. 12 represents a portion of a route planning map for San Francisco, Calif. identifying segments to be avoided based on analysis of taxicab data.

FIGS. 13-16 each represents an optimized route planning map for San Francisco, Calif. generated by the use of an embodiment of the present invention digital map optimization system or method, which provides a comparison to the generated conventional suggested route.

### DETAILED DESCRIPTION OF EXEMPLARY EMBODIMENTS

Effective development, optimization, and maintenance of digital network maps is increasingly critical for the efficient operation of public and private sector transportation and logistics route planning and fleet management software systems. Route planning systems require a digital network map consisting of two basic reference lists in order to function: a) a collection or ‘map’ of network segments and their nodal connections within a geographic area of interest, such as but not limited to, road or bicycle/pedestrian path networks, delivery areas, or military deployment regions to be represented and b) weight estimates for each network segment (referred to within this document as ‘arc costs’, ‘arc weights’, or ‘edge weights’) that allow the route planning software to determine an ‘optimal’ route for a user by comparing the total relative ‘arc costs’ of network segment combinations.

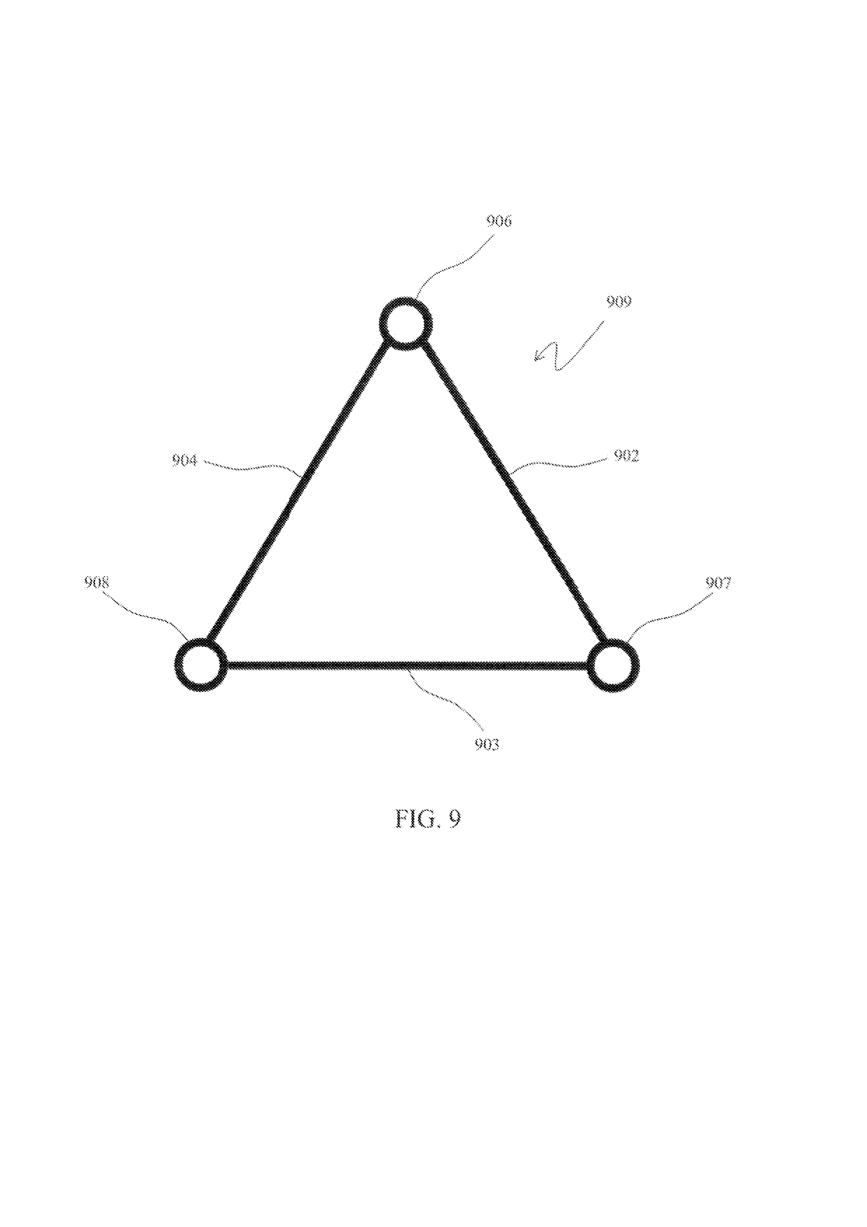

Referring to FIG. 9, provided is a schematic diagram of a route planning digital map 909 intended for an aspect of an embodiment of the present invention digital map optimization system and method that includes a collection of nodes 906, 907, and 908, and arcs 902, 903, and 904 whereby an arc is defined as a segment between a pair of nodes.

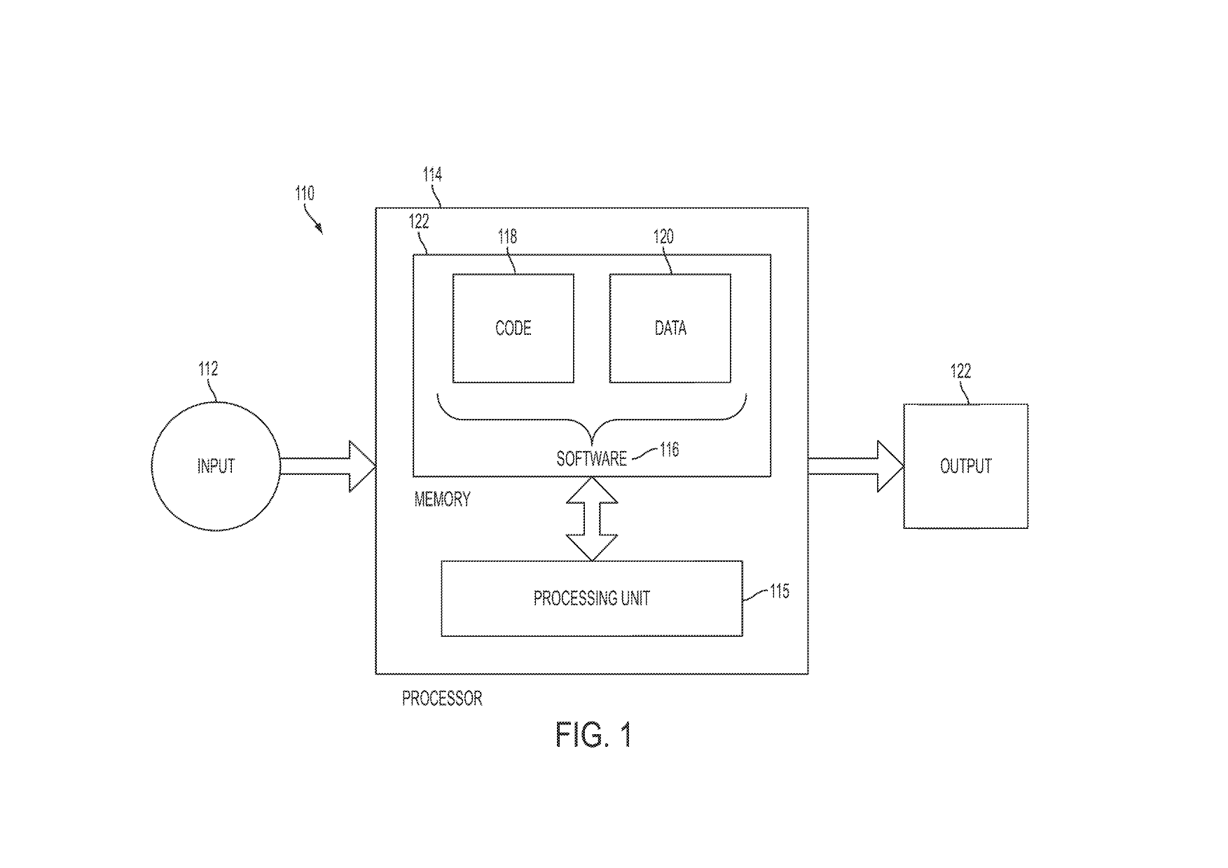

An aspect of an embodiment of the present invention provides, but not limited thereto, a system for determining an optimum route planning digital map. Referring to FIG. 1, provided is a schematic of an approach of the digital map optimization system 110 to be applied onto a first route planning digital map as provided by way of input module 112, for example. By way of the input module 112, a first route planning digital map is received by the processor 114 and includes a collection of nodes and arcs whereby an arc is defined as a segment between a pair of nodes. Via the input module 112, preferred route data is provided to the processor 114, wherein, the preferred route data comprises a collection of arcs representing a collection of routes that an entity finds preferable with respect to some unquantified criterion. The processing unit 115, for example, is in communication with a memory module 122. Next, an algorithm as represented by the software module 116, having code 118 and data 120, is configured to assign arc costs to said arc. The assigned arc cost is determined by synthesizing the preferred route data together with a distribution over baseline arc costs. Next, the assigned arc costs are applied to the first route planning digital map to provide an optimized route planning digital map. A storage device is provided for, among other things, storing the optimized route planning digital map by way of the memory module 122, or a secondary memory module (not shown), as well as a combination of both of or additional memories. Alternatively, or in addition to the aforementioned memories, an output module 124 may be provided for outputting the optimized route planning digital map for intended, desired or required use.

Still referring to FIG. 1, in an approach of an embodiment the present invention there may include a system 110 for determining an optimum route planning digital map to be applied onto a first route planning digital map. The system 110 may include a) a memory component 122 configured to store 1) the first route planning digital map that comprises a collection of nodes and arcs, whereby an arc is defined as a segment between a pair of nodes and 2) preferred route data, whereby the preferred route data may comprise a collection of arcs representing a collection of routes that an entity finds preferable with respect to some unquantified criterion. The system 110 may also include a processor module 114 in communication with the memory component 122. The processor module may be configured to: 1) assign arc costs to the arc, whereby the assigned arc cost is determined by synthesizing the preferred route data together with a distribution over baseline arc costs, 2) apply the assigned arc costs to the first route planning digital map to provide an optimized route planning digital map, and 3) perform at least one of the following: a) storing the optimized route planning digital map for use; or b) communicating the optimized route planning digital map for use with an output device or other processor based system.

The preferred route data comprises a collection of arcs representing a collection of routes that an entity finds preferable with respect to some unquantified criterion. For instance, the entity may be an individual, individuals, or a specialized user; or any combination thereof. A specialized user may be, for example, the following: taxi cab driver, bicyclist, route planner for emergency medical service, route guidance for parcel delivery, real estate agent, various businesses as desired or required, military personnel, manned or un-manned military vehicles, disaster recovery personnel, etc. An individual could be, for example, human, animal, robot, amphibian or reptile. Regarding the arc costs that are applied to a first or existing digital network map as part of the present invention algorithm and related method and system, the arc costs may include the following data or information: travel time, safety, speed limit, congestion, road segment avoidance, road-absence activity, distance, penalties, road width, road conditions, weather, event, episode, and terrain.

In an embodiment, the road-absence activity provides a means for rapid identification of missing or broken network segments in first or existing digital network maps. For instance, wherein the original or first route planning digital map has a digital ‘hole’ then this causes information on part of the digital map to be missing thus potentially interfering with or preventing optimal operation of route planning systems utilizing the first or existing digital map. Notwithstanding the existence of a digital hole (or missing information) it can be observed that a given entity is utilizing a road or path that corresponds to the missing area of the digital map. By introducing type of arc cost as “road-absence activity” then if it is observed that an activity is occurring essentially where there is no data (or absence of information) to support it on the digital map then it can be concluded that such activity is occurring where a road is absent on the first or existing map. Identifying digital holes or absent road segments in this way allows the first or existing digital map to be updated directly. (Note: the term ‘road’ used in reference to ‘digital holes’ and ‘road-absence activity’ is inclusive of, but not limited to, any form of network segment or node with demonstrated activity but no representation on an existing map. This can include, but is not limited to, well-defined yet unrepresented ‘road’ segments such as walking and biking paths, or flight corridors. Importantly, it can also include previously unrepresented ‘informal’ network segments such as, but not limited to, predominant pedestrian paths through public plazas, informal urban biking or pedestrian short-cuts, off-network manned or un-manned military vehicle or troop movements.)

The synthesizing accomplished by the algorithm is performed by inferring arc costs using a probabilistic model. The inferred arc costs are chosen by deriving estimates from the probabilistic model. It should be appreciated that the probabilistic models may be a variety of available models as desired or required by someone skilled in the art and/or user of an embodiment of the present invention. For instance, a probabilistic model that may be implemented is a Bayesian model, which is merely an illustrative example and is not to be construed as a limitation. Utilizing the Bayesian model, the inferred arc costs may be chosen, for example, as maximum a-posteriori probability (MAP) estimates. Maximum a-posteriori probability (MAP) estimates technique is not meant to serve as a limitation. Other available estimating methodologies may be implemented as desired or required by someone skilled in the art and/or user of an embodiment of the present invention. Additionally, the MAP estimates of the inferred arc costs are computed using sequential unconstrained minimization technique. The sequential unconstrained minimization technique is not meant to serve as a limitation. Other available computational methods may be implemented as desired or required by someone skilled in the art and/or user of an embodiment of the present invention.

Still referring to FIG. 1, the preferred route data may be received or originate from a source including at least one of: manual communication entry; GPS communication; internet communication, or memory storage of preferred route data; or any combination thereof. Moreover, the preferred route data may be received from a source including at least one of: triangulation system, accelerometer system, transponder system, radio frequency system, blue tooth communication system, RFID system, or gyro; or any type of available tracking systems, devices, and/or software.

Still referring to FIG. 1, the assigned arc costs may be updated in real-time. Similarly, the preferred route data is received in real time. Still further yet, both the updating of the assigned arc costs and receiving of the preferred route data may be are accomplished in real time.

Still referring to FIG. 1, for illustrative purposes and not to be construed as limiting the scope of the invention, the digital map optimization system 110 may be utilized for commercial or personal transportation, parcel delivery, taxi or limousine service, military logistics and transportation, emergency medical services (EMS), disaster response, shipping logistics, and evacuation route planning; or any combination thereof. In an approach, the output module is in communication with an interface device or component. Some illustrative examples of an interface, but not limited thereto, includes the following: a modem, a network interface (such as an Ethernet card), a communications port (e.g., serial or parallel, etc.), a PCMCIA slot and card, a modem, (or any combination thereof) etc.

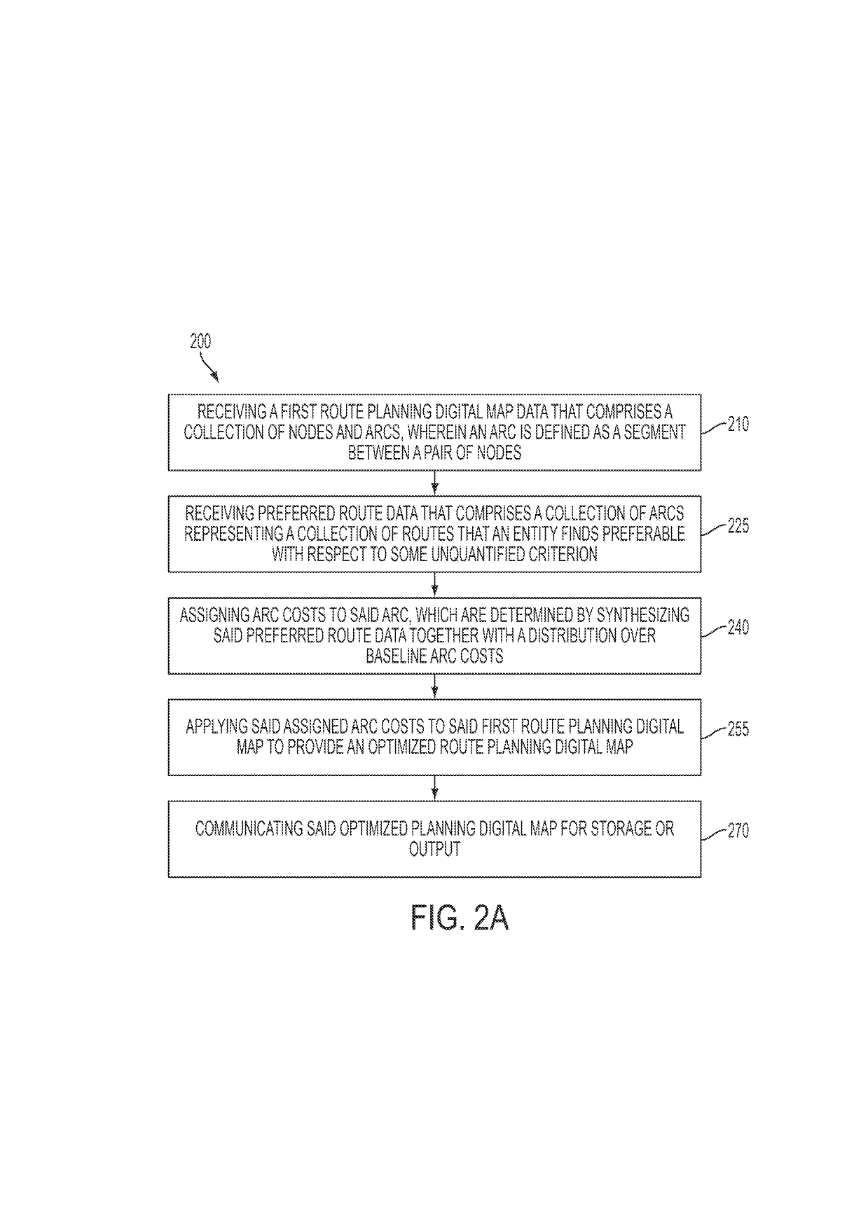

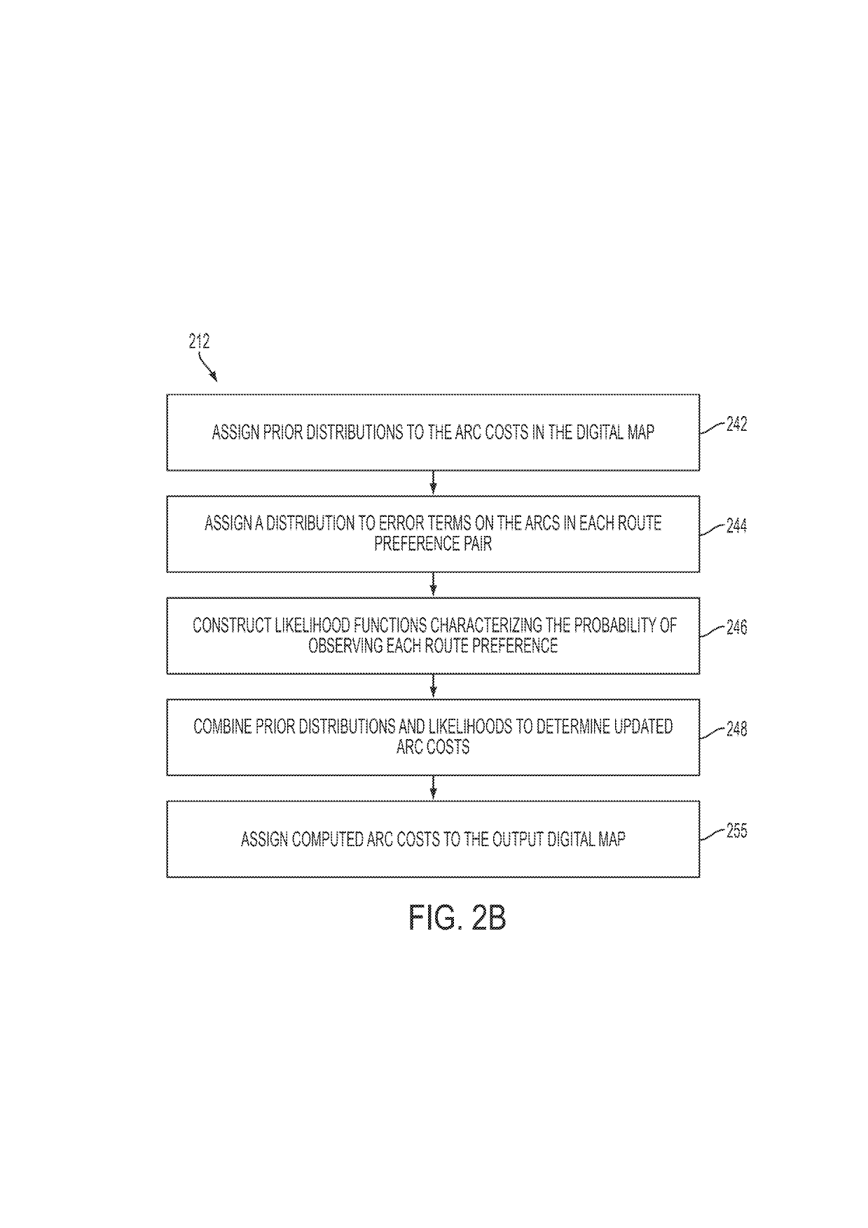

Referring to FIG. 2A, a flowchart is provided illustrating an aspect of an embodiment of the present invention computer implemented method 200 for determining an optimum route planning digital map. In step 210, the method includes receiving a first route planning digital map data that comprises a collection of nodes and arcs, wherein an arc is defined as a segment between a pair of nodes. In step 225, the method includes receiving preferred route data that comprises a collection of arcs representing a collection of routes that an entity finds preferable with respect to some unquantified criterion. In step 240, the method includes assigning arc costs to said arc, which are determined by synthesizing said preferred route data together with a distribution over baseline arc costs. In step 255, the method includes applying said assigned arc costs to said first route planning digital map to provide an optimized route planning digital map. In step 270, the method includes communicating said optimized planning digital map for storage or output.

Referring to FIG. 2B, a flowchart is provided illustrating an embodiment of the computer implemented method 212 that is related to the assigning of the arc costs as described in step 240, as previously discussed in the flowchart of FIG. 2A. For instance, an approach of determining the preferred route data may further include step 242, whereby the method includes assigning prior distributions to the arc costs in the digital map. The prior distribution characterizes a range of reasonable values for the modified arc costs. For example, if it is to be believed that the modified arc costs should be assigned values that are close to the distance of the road segment represented by the arc, then it may be that a prior distribution is chosen that is centered around the distance of the segment. Prior distributions is a component that may be attained in Bayesian statistical inference methods (or other optimization methodologies). Further, in step 244, the method includes assigning a distribution to error terms on the arcs in each route preference pair. The route preference data will necessarily contain some variation and inconsistencies. For example, the preferences of one person might conflict with the preferences of another person. As another example, preferences observed on a particular day might be the result of an incident that only affected traffic on that day. The error terms allow the algorithm or method to model the variability across route preferences. By carefully selecting the error terms, the algorithm or method can more heavily weigh the route preferences that are believed to be more meaningful. For example, preferences observed in older routes might be more likely to be the result of “errors” that are not relevant to the preference criteria of which the algorithm or method would want to extract from the data. Error terms may be implemented wherein similar terms are used to explain inconsistencies and variability in observations. Further yet, in step 246, the method includes constructing likelihood functions characterizing the probability of observing each route preference. The likelihood functions model the probability that a particular route preference would be observed, given a particular assignment of arc costs. The likelihoods are calculated from the distributions of the error terms. Likelihood functions are a component attained in Bayesian statistical inference methods (as well as other optimization methodologies). Still yet, in step 248, the method includes combining prior distributions and likelihoods to determine updated arc costs. In this embodiment, the approach includes implementing Bayesian inference methods to estimate the arc costs from the model we've constructed. Further, in the applicants' experiments, maximum a-posteriori probability (MAP) estimates have been used that are derived from the Bayesian model. In step 255, and as also discussed in FIG. 2A, the method includes assigning computed arc costs to the output digital map. The output from applying the algorithm enables the capability to generate an updated digital map as reflected by the newly calculated costs.

For instance, a manner of determining the preferred route data may be implemented based on Bayesian statistics. However, it should be appreciated that other statistical optimization methods and algorithms may be implemented, and therefore utilizing Bayesian statistics should not be construed as limiting the invention. In this approach, the method includes building a probability model relating costs that could be assigned to segments with the possibility of observing various route preferences. Using this model, the method can estimate good choices for the costs given a collection of observed preferences. For instance, in step 242, the method includes assigning prior distributions to the arc costs in the digital map. A digital map describes a road network by a set of nodes V, and a set of arcs E⊂V×V. For every arc eεE, there is typically a cost cₑ assigned to this arc. The initial baseline arc costs, cₑ, will be modified by an embodiment of the present invention algorithm. As a starting point, a prior distribution fₑ(xₑ) of reasonable arc costs will be assigned to each arc e. The variable xₑ represents the various updated arc costs that could be assigned to arc e.

One distribution that may be implemented is the gamma distribution with mode cₑ,

$${f}_{e} ( {x}_{e} ) = {x}_{e}^{k - 1} \frac{{( k - 1 )}^{k} exp ( - ( k - 1 ) {x}_{e} / {c}_{e} )}{Γ ( k ) {c}_{e}^{k}} .$$

Assuming priors are independent, the joint prior on all arc costs is

$${\prod }_{e ε E} {f}_{e} ( {x}_{e} ) .$$

In step 244, the method includes assigning a distribution to error terms on the arcs in each route preference pair. As input data, we are given a collection of route preference pairs (Rᵢ, R′ᵢ), wherein each route is a subset of arcs in E. In the preference pair (Rᵢ, R′ᵢ), the route Rᵢ is preferable to the route R′ᵢ. An embodiment of the present invention method can assign each arc e appearing in either Rᵢ or R′ᵢ the arc cost xₑ+εₑᵢ. The error term εₑᵢ is assigned a probability distribution. Typically, an embodiment of the present invention method uses a zero-mean Gaussian distribution with variance σᵢ². That is,

$${f}_{ei} ( {ε}_{ei} ) = \frac{1}{\sqrt{2 {πσ}_{i}^{2}}} exp ( - {ε}_{ei}^{2} / 2 {σ}_{i}^{2} ) .$$

An approach of an embodiment may treat all of the error terms as independent.

Further yet, in step 246, the method includes constructing likelihood functions characterizing the probability of observing each route preference. For given arc costs xₑ and error terms εₑᵢ, an approach of an embodiment may provide that route Rᵢ would be found preferable to R′ᵢ if

$${\sum }_{e ε {R}_{i}} ( {x}_{e} + {ε}_{ei} ) \leq {\sum }_{e ε {R}_{i}^{′}} ( {x}_{e} + {ε}_{ei} ) .$$

For given arc costs an approach of an embodiment may like to find the probability that route Rᵢ is preferable to route R′ᵢ. Since an approach has modeled the error terms as independent and Gaussian, a significant simplification arises. The inequality (1) can be rewritten as

$${\sum }_{e ε {R}_{i}} {x}_{e} - {\sum }_{e ε {R}_{i}^{′}} {x}_{e} \leq {ε}_{i} .$$

where ε₁ is a zero mean Gaussian random variable with variance

$${\sum }_{e ε {R}_{i} Δ {R}_{i}^{′}} {σ}_{e}^{2} .$$

The probability that route preference i is satisfied given the arc costs xₑ is

$$1 - {F}_{i} ( {\sum }_{e ε {R}_{i}} {x}_{e} - {\sum }_{e ε {R}_{i}^{′}} {x}_{e} ) .$$

where Fᵢ is the cumulative distribution function of εᵢ. Since the error terms are independent, the probability that all m route preferences are satisfied given that arc costs xₑ are used is

$${\prod }_{i = 1}^{m} ( 1 - {F}_{i} ( {\sum }_{e ε {R}_{i}} {x}_{e} - {\sum }_{e ε {R}_{i}^{′}} {x}_{e} ) ) .$$

Still yet, in step 248, the method includes combining prior distributions and likelihoods to determine updated arc costs. To compute the MAP estimates of the arc costs, an embodiment may want to find the set of costs xₑ that maximize

$${\prod }_{e ε E} {f}_{e} ( {x}_{e} ) {\prod }_{i = 1}^{m} ( 1 - {F}_{i} ( {\sum }_{e ε {R}_{i}} {x}_{e} - {\sum }_{e ε {R}_{i}^{′}} {x}_{e} ) ) .$$

As is commonly done, an embodiment can equivalently minimize the negative logarithm of this expression. For the case of gamma priors and Gaussian error terms, this reduces to minimizing

$$( k - 1 ) {\sum }_{e ε E} ( \frac{{x}_{e}}{{c}_{e}} - ln ( {x}_{e} ) ) - {\sum }_{i = 1}^{m} ln ( 1 - {F}_{i} ( {\sum }_{e ε {R}_{i}} {x}_{e} - {\sum }_{e ε {R}_{i}^{′}} {x}_{e} ) ) .$$

This novel mathematical approach, which may be an important aspect of an embodiment of the present invention, transforms the assignment of arc costs within the updated digital network map (e.g., digital route map) into a standard convex optimization problem, and can be solved using gradient descent algorithms or other optimization methodologies familiar to those skilled in the art. Accordingly, this approach provides an important aspect whereby problem is reduced into a convex optimization problem, which in turn can be solved with a number of techniques.

In step 255, and as also discussed in FIG. 2A, the method includes assigning computed arc costs to the output digital map. The output from applying the algorithm enables the capability of generating an updated digital map as reflected by the newly calculated costs.

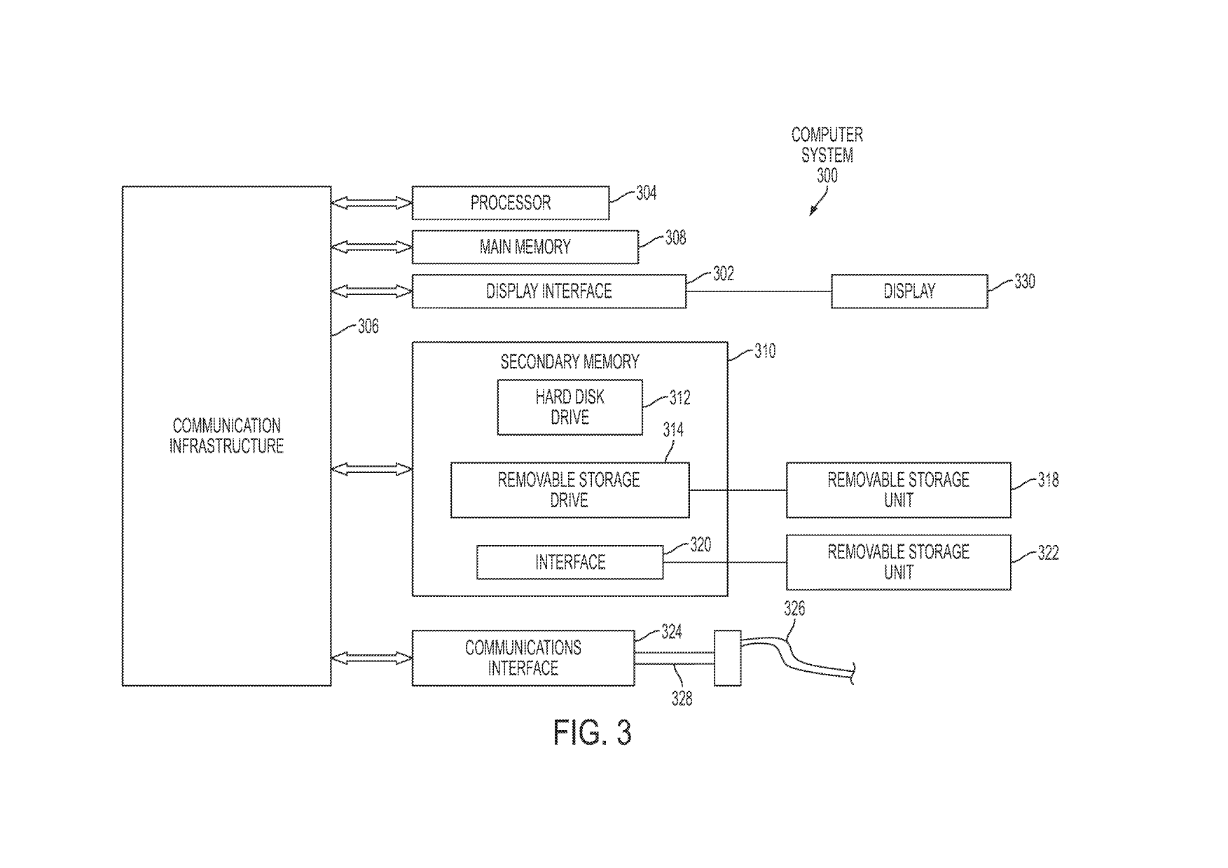

Turning to FIG. 3, FIG. 3 is a functional block diagram for a computer system 300 for implementation of an exemplary embodiment or portion of an embodiment of present invention. For example, a method or system of an embodiment of the present invention may be implemented using hardware, software or a combination thereof and may be implemented in one or more computer systems or other processing systems, such as personal digit assistants (PDAs) equipped with adequate memory and processing capabilities. In an example embodiment, the invention was implemented in software running on a general purpose computer 30 as illustrated in FIG. 3. The computer system 300 may includes one or more processors, such as processor 304. The Processor 304 is connected to a communication infrastructure 306 (e.g., a communications bus, cross-over bar, or network). The computer system 300 may include a display interface 302 that forwards graphics, text, and/or other data from the communication infrastructure 306 (or from a frame buffer not shown) for display on the display unit 330. Display unit 330 may be digital and/or analog.

The computer system 300 may also include a main memory 308, preferably random access memory (RAM), and may also include a secondary memory 310. The secondary memory 310 may include, for example, a hard disk drive 312 and/or a removable storage drive 314, representing a floppy disk drive, a magnetic tape drive, an optical disk drive, a flash memory, etc. The removable storage drive 314 reads from and/or writes to a removable storage unit 318 in a well known manner. Removable storage unit 318, represents a floppy disk, magnetic tape, optical disk, etc. which is read by and written to by removable storage drive 314. As will be appreciated, the removable storage unit 318 includes a computer usable storage medium having stored therein computer software and/or data.

In alternative embodiments, secondary memory 310 may include other means for allowing computer programs or other instructions to be loaded into computer system 300. Such means may include, for example, a removable storage unit 322 and an interface 320. Examples of such removable storage units/interfaces include a program cartridge and cartridge interface (such as that found in video game devices), a removable memory chip (such as a ROM, PROM, EPROM or EEPROM) and associated socket, and other removable storage units 322 and interfaces 320 which allow software and data to be transferred from the removable storage unit 322 to computer system 300.

The computer system 300 may also include a communications interface 324. Communications interface 324 allows software and data to be transferred between computer system 300 and external devices. Examples of communications interface 324 may include a modem, a network interface (such as an Ethernet card), a communications port (e.g., serial or parallel, etc.), a PCMCIA slot and card, a modem, etc. Software and data transferred via communications interface 324 are in the form of signals 328 which may be electronic, electromagnetic, optical or other signals capable of being received by communications interface 324. Signals 328 are provided to communications interface 324 via a communications path (i.e., channel) 326. Channel 326 (or any other communication means or channel disclosed herein) carries signals 328 and may be implemented using wire or cable, fiber optics, blue tooth, a phone line, a cellular phone link, an RF link, an infrared link, wireless link or connection and other communications channels.

In this document, the terms “computer program medium” and “computer usable medium” are used to generally refer to media or medium such as various software, firmware, disks, drives, removable storage drive 314, a hard disk installed in hard disk drive 312, and signals. These computer program products (“computer program medium” and “computer usable medium”) are means for providing software to computer system 300. The computer program product may comprise a computer useable medium having computer program logic thereon. The invention includes such computer program products. The “computer program product” and “computer useable medium” may be any computer readable medium having computer logic thereon.

Computer programs (also called computer control logic or computer program logic) may be stored in main memory 308 and/or secondary memory 310. Computer programs may also be received via communications interface 324. Such computer programs, when executed, enable computer system 300 to perform the features of the present invention as discussed herein. In particular, the computer programs, when executed, enable processor 304 to perform the functions of the present invention. Accordingly, such computer programs represent controllers of computer system 300.

In an embodiment where the invention is implemented using software, the software may be stored in a computer program product and loaded into computer system 300 using removable storage drive 314, hard drive 312 or communications interface 324. The control logic (software or computer program logic), when executed by the processor 304, causes the processor 304 to perform the functions of the invention as described herein.

In another embodiment, the invention is implemented primarily in hardware using, for example, hardware components such as application specific integrated circuits (ASICs). Implementation of the hardware state machine to perform the functions described herein will be apparent to persons skilled in the relevant art(s).

In yet another embodiment, the invention is implemented using a combination of both hardware and software.

In an example software embodiment of the invention, the methods described above may be implemented in SPSS control language or C++ programming language, but could be implemented in other various programs, computer simulation and computer-aided design, computer simulation environment, MATLAB, or any other software platform or program, windows interface or operating system (or other operating system) or other programs known or available to those skilled in the art.

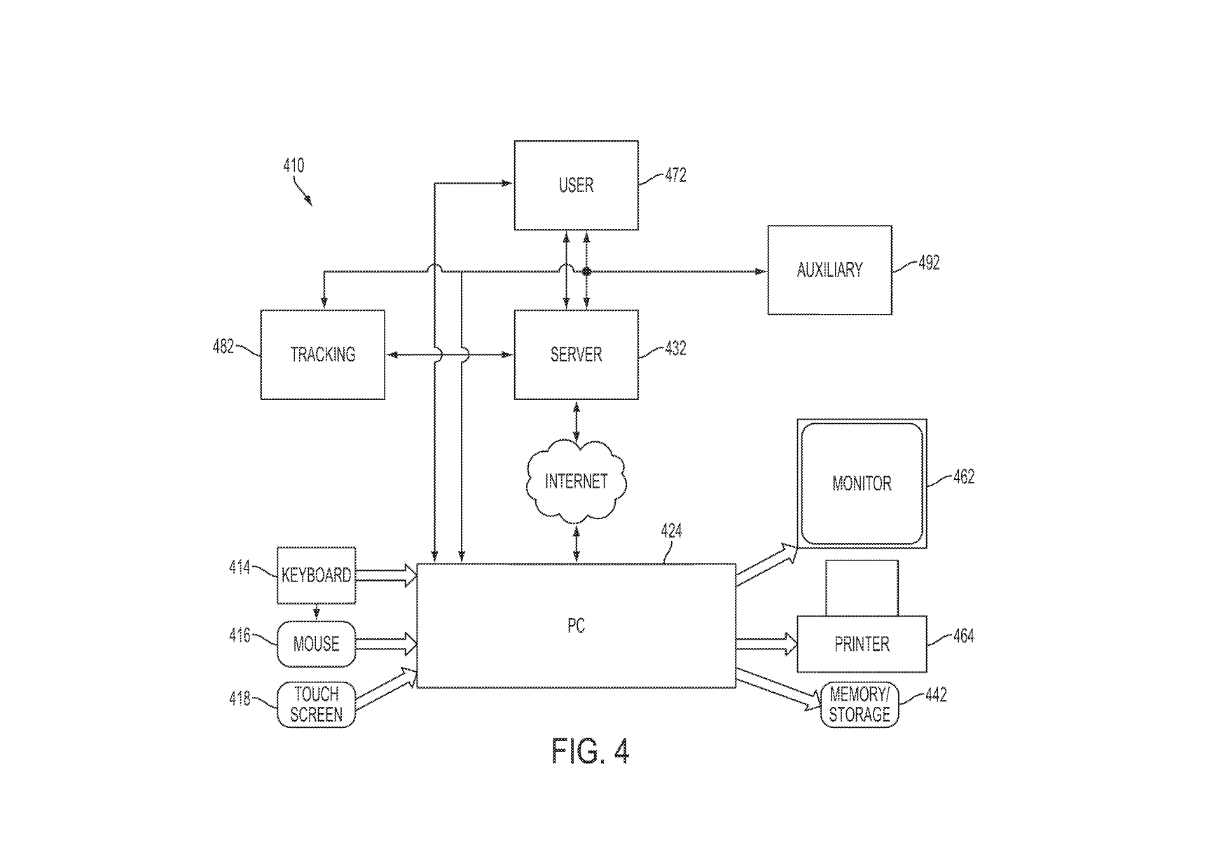

FIG. 4 is a schematic block diagram for a system or related method of an embodiment of the present invention in whole or in part. Referring to FIG. 4, provided is a schematic of an approach of the digital map optimization system 410 to be applied onto a first route planning digital map as provided by way of input module, for example keyboard 414, mouse 416, and/or touch screen 418. Other examples of input modules (not specifically illustrated) include, but not limited thereto, trackball, stylus, touch pad, steering wheel buttons, microphone, joystick, game pad, satellite dish, scanner, TV tuner card, digital camera, digital video camera, web camera, remote control, and the like. Input function may also be accomplished via the server 432, user 472, tracking module 482, or auxiliary module 492, or some combination thereof. The server 432 is equipped with the prerequisite web software, hardware or firmware and the PC 424 may be equipped with the necessary browser software. Similarly, any of the related input functions or modules of FIG. 4 (as well as discussed throughout this disclosure) may be supported by the adequate software, hardware or firmware. By way of the input module a first route planning digital map, among other things, is received by the processor, such as a personal computer 424 (or any processing system, such as PDAs, equipped with adequate memory and processing capabilities) and includes a collection of nodes and arcs whereby an arc is defined as a segment between a pair of nodes. An algorithm as it pertains to related method as discussed throughout this disclosure is implemented at the PC 424 for instance. Alternatively, the algorithm may be implemented at the PC or remotely at the server 430, tracking module 482, or auxiliary module 492, or some combination thereof. Next, the assigned arc costs are applied to the first route planning digital map to provide an optimized route planning digital map. Storage capabilities are provided for, among other things, storing the optimized route planning digital map by way of a memory (not shown) as part of the PC or outputted to an external memory module 442, or a secondary memory module (not shown), to the server 432, the user 472, tracking module 482, or auxiliary module 492, as well as a combination of utilizing any of the memory modules discussed herein. Alternatively, or in addition to the aforementioned memory modules, an output module may be provided for outputting the optimized route planning digital map for use through a monitor 462 and/or printer 464, as well as any graphical user interface.

Still refereeing to FIG. 4, the preferred route data that is received by the processor can be received by any input mechanism such as from the input modules, server 432, user 472, auxiliary module 492, or tracking module 482. The source for the preferred data, for instance, may be manual communication entry; GPS communication; internet communication, or memory storage of preferred route data. Still yet, the source for the preferred data, for instance, may be from a triangulation system, accelerometer, or gyro. An example of a tacking module 482 is, but not limited thereto, a GPS or triangulation via cellular stations.

It should be appreciated that the various communication paths, links and channels shown between all of the modules, equipment or devices illustrated in FIGS. 1 and 4-8 may be implemented using a variety of means adequate for transferring or communicating signals or data, including, but not limited thereto, the following: wire, cable, internet, wireless, fiber optic, blue tooth, telephone line, cellular phone link, RF link, and infrared link, as well as any other available means of communication.

It should be appreciated that the auxiliary module discussed herein may be any combination of at least one of the following: input module, output module, processor module, server module, satellite system, GPS, mobile phone, PDA, tracking module, communication system, vehicle system, navigation system, storage medium, internet-enabled device, or database.

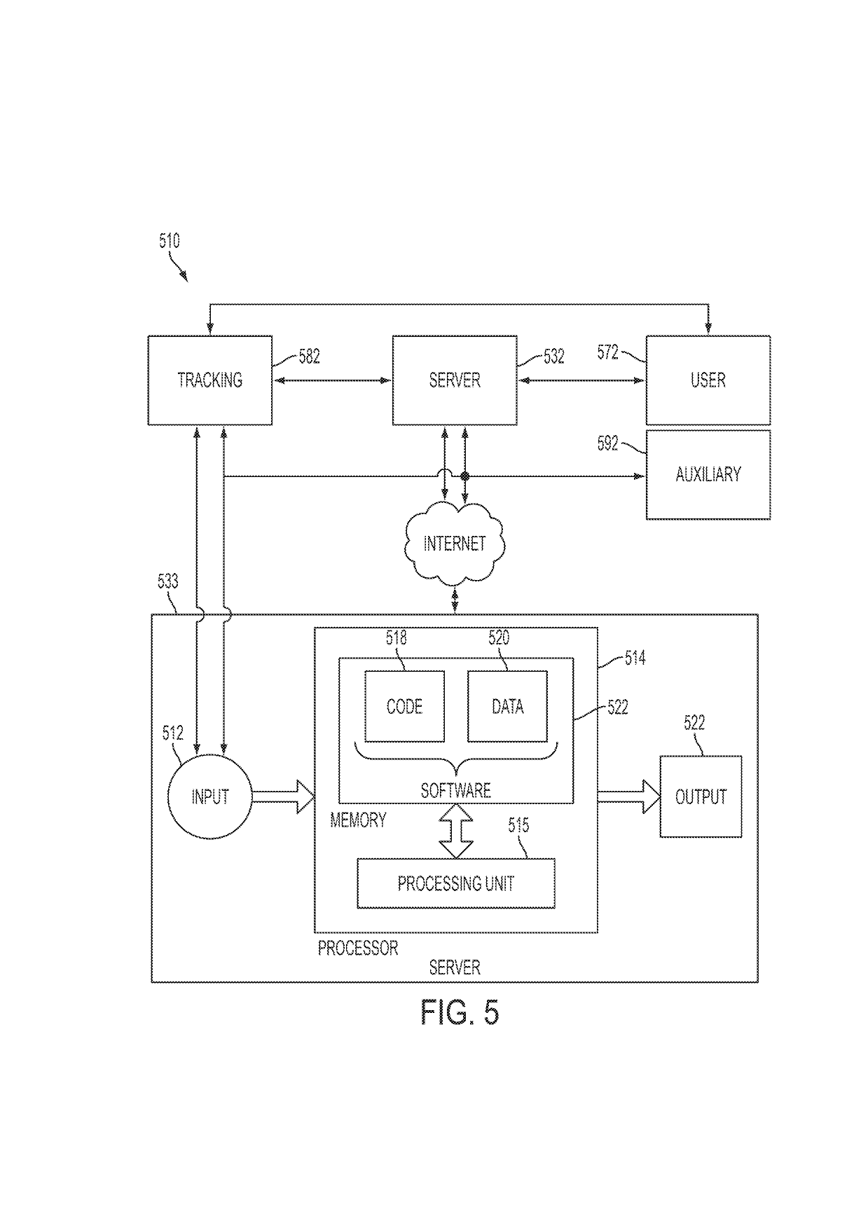

FIG. 5 is a schematic block diagram for a system or related method of an embodiment of the digital map optimization system 510 similarly disclosed in FIG. 4 with a modification that additional aspects may be performed remotely such as on various servers. For instance, a number of modules are associated remotely with a server 533. The system 510 may be implemented with a variety of modules such as tracking module 582; server 532; user 572; auxiliary module 592; input module 512 or related function; software 518 including code 518 and data 520; memory 522; processor 514 with an associated processing unit 515; output module 522 or related function; and server 533.

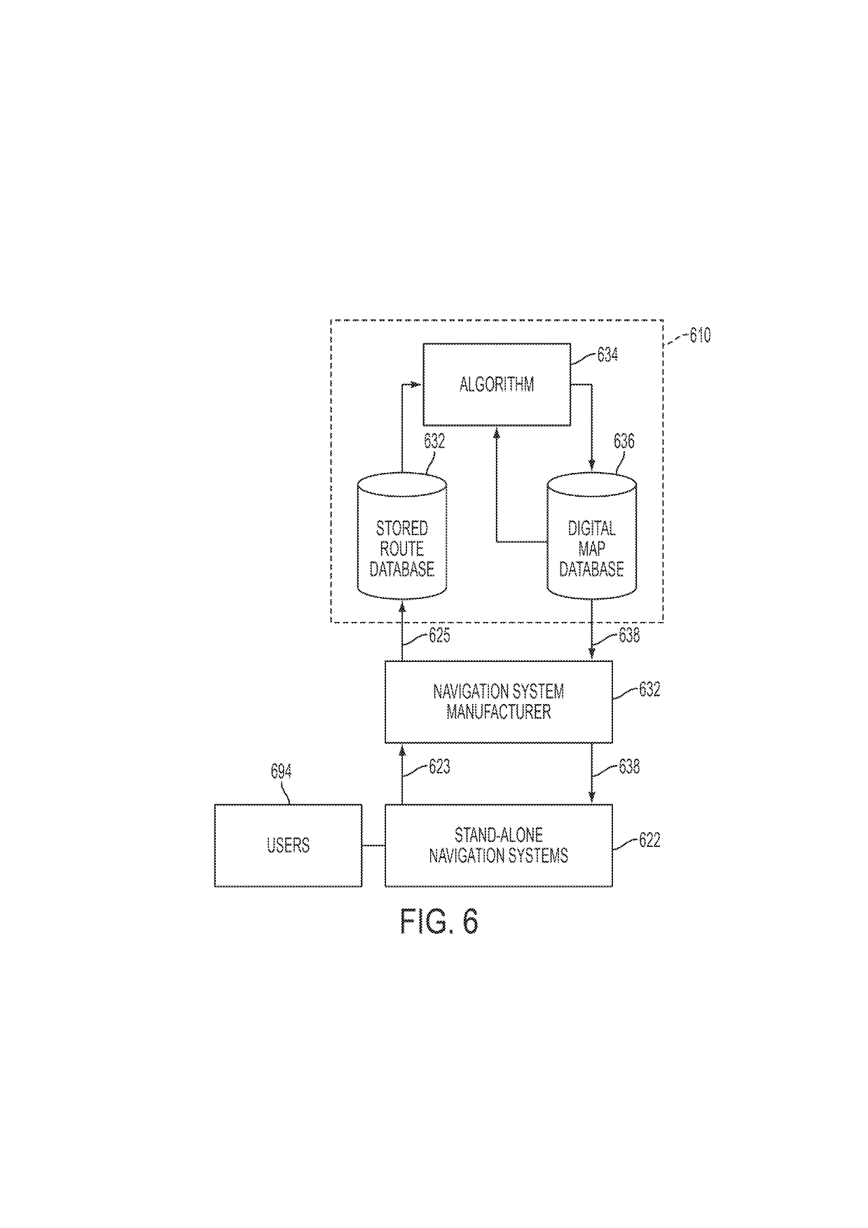

FIG. 6 is a schematic block diagram for a system or related method of an embodiment of the present invention in whole or in part. FIG. 6 provides an illustration of an approach whereby, for example but not limited thereto, navigation systems can use an embodiment of the present invention digital map optimization system 610 and related method to improve the relevance of their route guidance. Users 694 of their respective navigation systems 622 (for example, stand alone navigations such GPS) upload data on their traveled (captured) routes 623 to the navigation system manufacturer module 632 (such as the GPS manufacture's server). This data (captured data) 625 on traveled routes is provided to the digital map optimization system 610 to be received by the stored route database 632. The digital map optimization system 610 system selects arc costs on a digital map that are consistent with the traveled routes using the optimization algorithm 634 to compute the optimized digital map stored in the optimized digital map data base 636. These new arc costs (in the form of digital map updates or optimized digital maps 638) are returned to the navigation system manufacturer 632. The navigation system manufacturer 632 provides the map updates 638 to its users 694 at the stand-alone navigation systems 622.

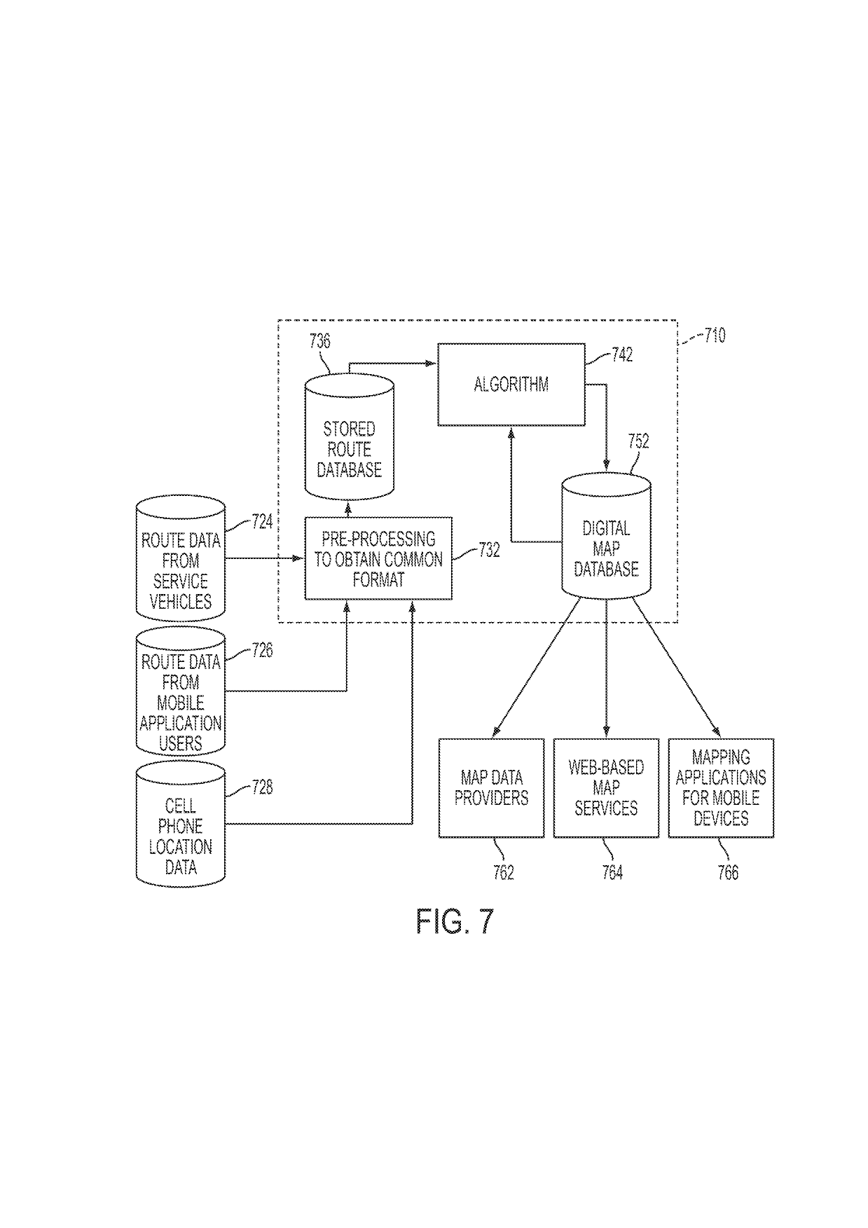

FIG. 7 is a schematic block diagram for a system or related method of an embodiment of the present invention in whole or in part. FIG. 7 provides an illustration of an approach that, for example but not limited thereto, an embodiment of the present invention digital map optimization system 710 and related method can be utilized to use multiple, existing data sources to improve existing digital maps. Data that is currently collected by service vehicles 724, smartphones or PDAs 726, and cell phone triangulation (or other applicable location data) 728 is provided to the system 710. This data is processed 732 to segment into individual routes on a digital map. For instance this may include processing to obtain a common format. The system selects arc costs on a digital map from a stored route data base 736 that are consistent with the traveled routes. The optimization algorithm 742 computes the optimized digital maps as it is in communication with digital map database 752. This updated map can be supplied to multiple consumers of digital maps, such as web-based mapping services 764 and mapping applications for smartphones or PDAs 766. Additionally, updated maps could be supplied directly to providers of digital map data 762.

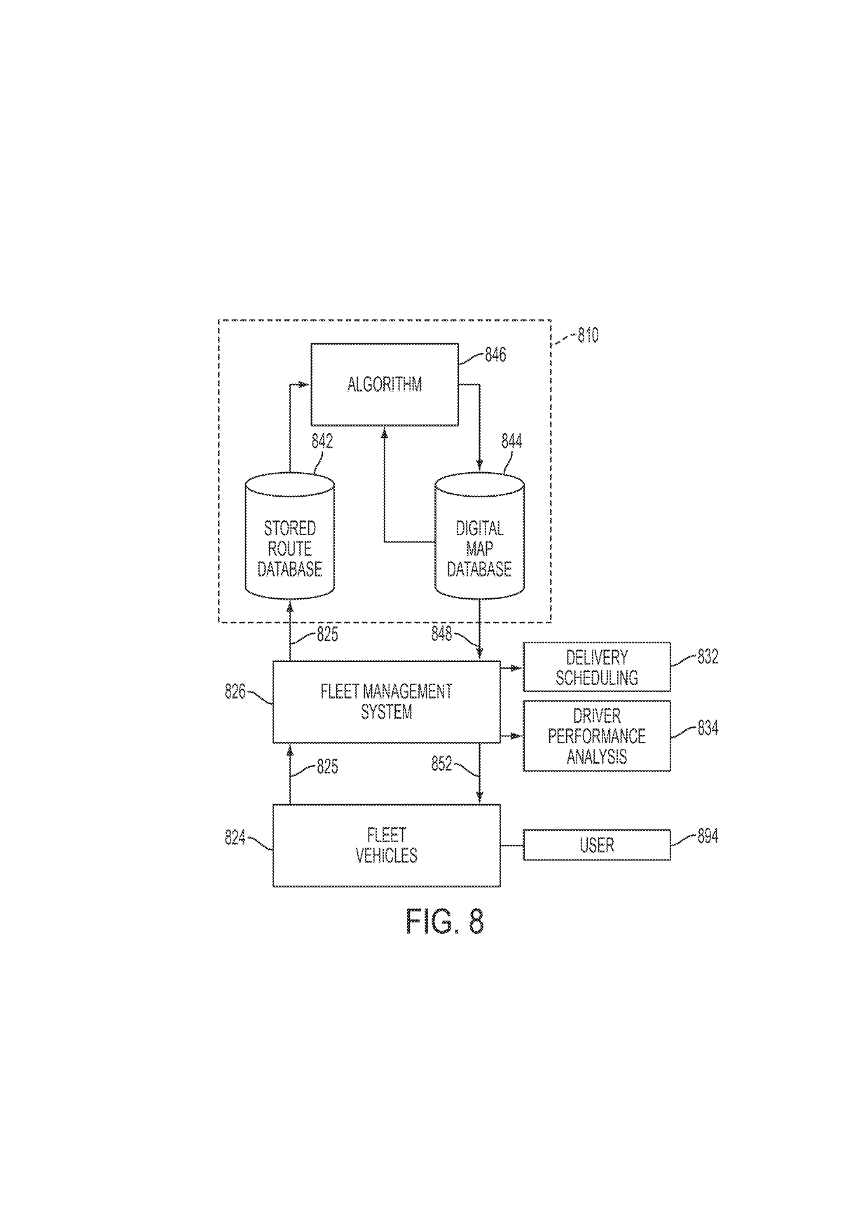

FIG. 8 is a schematic block diagram for a system or related method of an embodiment of the present invention in whole or in part. FIG. 8 provides an illustration of an approach whereby an embodiment of the present invention digital map optimization system 810 and related method can be utilized by, for example but not limited thereto, a fleet management system 826 so as to improve the relevance of their route guidance, improve delivery scheduling 832, and evaluate driver performance 834. Fleet vehicle routes are monitored and stored by existing fleet management systems 826. This captured route data 825 on fleet vehicle routes from the vehicles 824 used by users 894 is provided as stored routed data 842 to the system 810. The system 810 selects arc costs on a digital map from the digital map data base 844 using the optimization algorithm 846 that are consistent with the traveled routes. (4) These new arc costs—as digital map updates 848—are returned to the fleet management system 826. (5) The fleet management system 826 uses the updated map for route guidance 852, delivery scheduling 832, and driver performance evaluation 834.

An aspect of an embodiment of the present invention provides a system, method and computer program product for developing and/or maintaining a route planning digital map. Moreover, the route planning digital map may serve as the reference basis for location-based systems such as, but not limited to, route guidance, multi-modal transportation system monitoring, location-based consumer applications, and vehicle fleet administration. An exemplary embodiment may include providing the optimized route planning data to a location-based consumer application such as a store front, business front, or marketing application. A marketing application, for example, may utilize any route, driver, entity, or user information that can be provided for purpose of applying marketing practices (or other desired or required business practices); and whereby the route, driver, entity, or user information is gleamed, derived, or generated from the optimizing route planning data.

It should be appreciated that the term “arc cost” is interchangeable with the term “edge cost.” It should be appreciated that the term “arc” is interchangeable with the term “edge.” It should be appreciated that “arc costs” are interchangeable with the term “arc weight.” For purpose of this disclosure, the term “road” shall also be interpreted to include the following terms: road, bridge, tunnel, path, patch, pathway, trail, street, walkway, track, region, flight corridor, or segment. A region may be, for example, but not limited thereto, military deployment regions, other types of military regions, as well as various other general types of designated regions or areas of interest. An exemplary region may be areas that are occupied, such as stores, offices, malls, crowds, and congregations. The tracking of occupants (human, animal, etc.), for example, could be accomplished by visual and recognition tracking software. For the purpose of this disclosure “vehicle” shall include manned or un-manned automobile, aircraft, spacecraft, watercraft, motorcycle, bicycle, robot, or personnel body-based (whereby besides being based on humans, it could also be based on animals, reptiles or amphibians). For the purpose of this disclosure, the segments or arcs may be applicable for land, sea, space, or air.

### EXAMPLES

Practice of an aspect of an embodiment (or embodiments) of the invention will be still more fully understood from the following examples and experimental results, which are presented herein for illustration only and should not be construed as limiting the invention in any way.

### Experimental Results and Examples Set No. 1

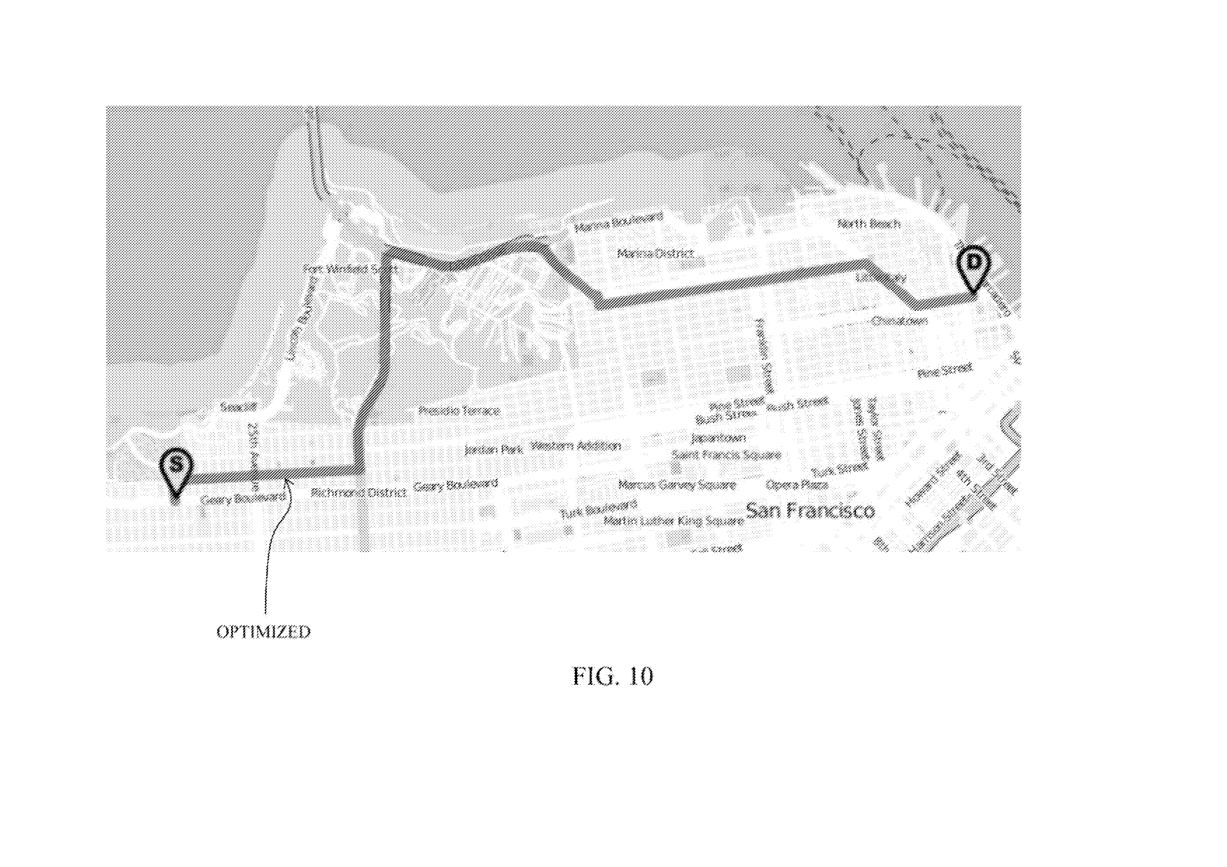

FIG. 10 represents an optimized route planning map for San Francisco, Calif. generated by the use of an embodiment of the present invention digital map optimization system or method. An aspect of the preferred data originated from the use of real-world data (taxi cabs) sample. The map illustrates the optimized route whereby the route is not necessarily the shortest available route (between the starting point, S, and destination point, D), but rather the most preferred route based on the algorithm of an embodiment generating the optimum route planning digital map.

### Experimental Results and Examples Set No. 2

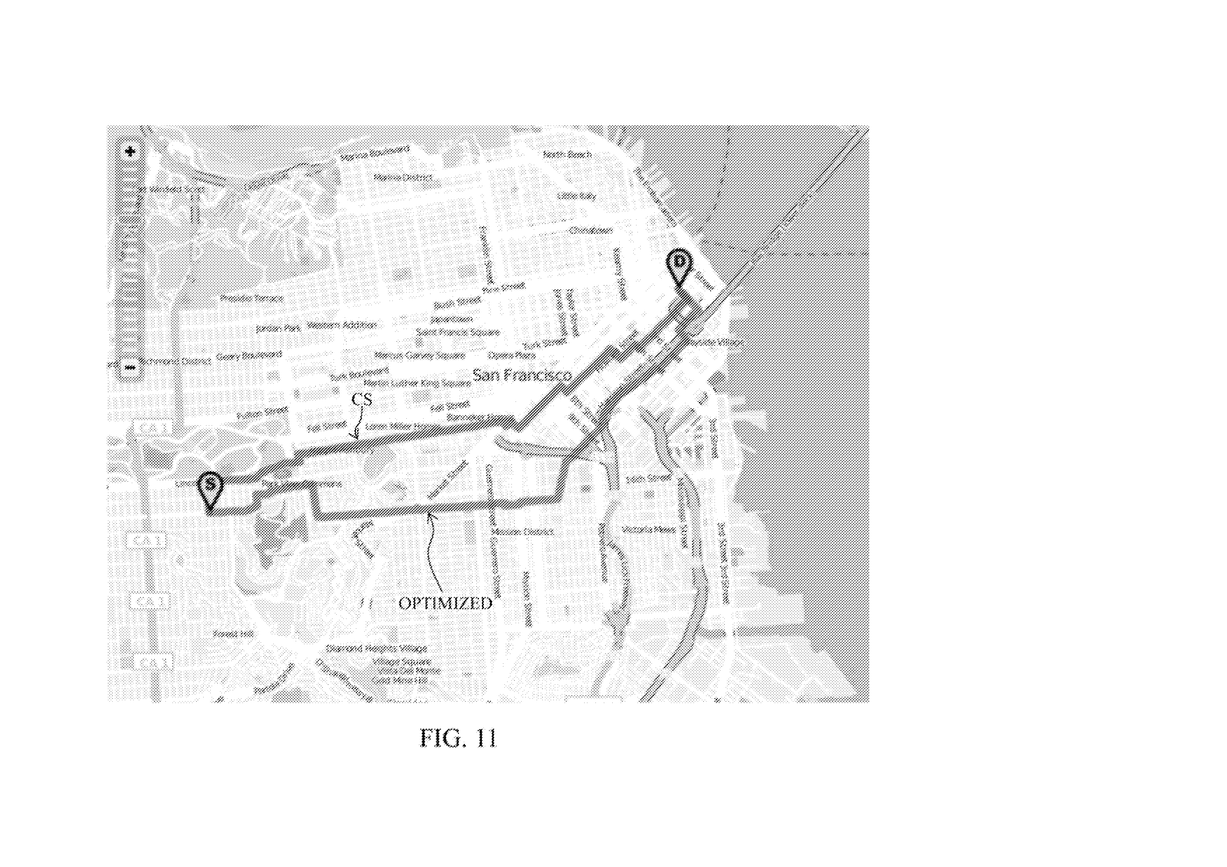

FIG. 11 represents an optimized route planning map for San Francisco, Calif. generated by the use of an embodiment of the present invention digital map optimization system or method, which provides a comparison to the generated conventional suggested route denoted as CS. The map illustrates the optimized route whereby the optimized route is not necessarily the route (between the starting point, S, and destination point, D) having the greatest speed limit, but rather the most preferred route based on the algorithm of an embodiment generating the optimum route planning digital map. Accordingly, the optimized route requires about 11.5 minutes of travel time versus the conventional suggested route, CS, that requires 15.4 minutes of travel.

### Experimental Results and Examples Set No. 3

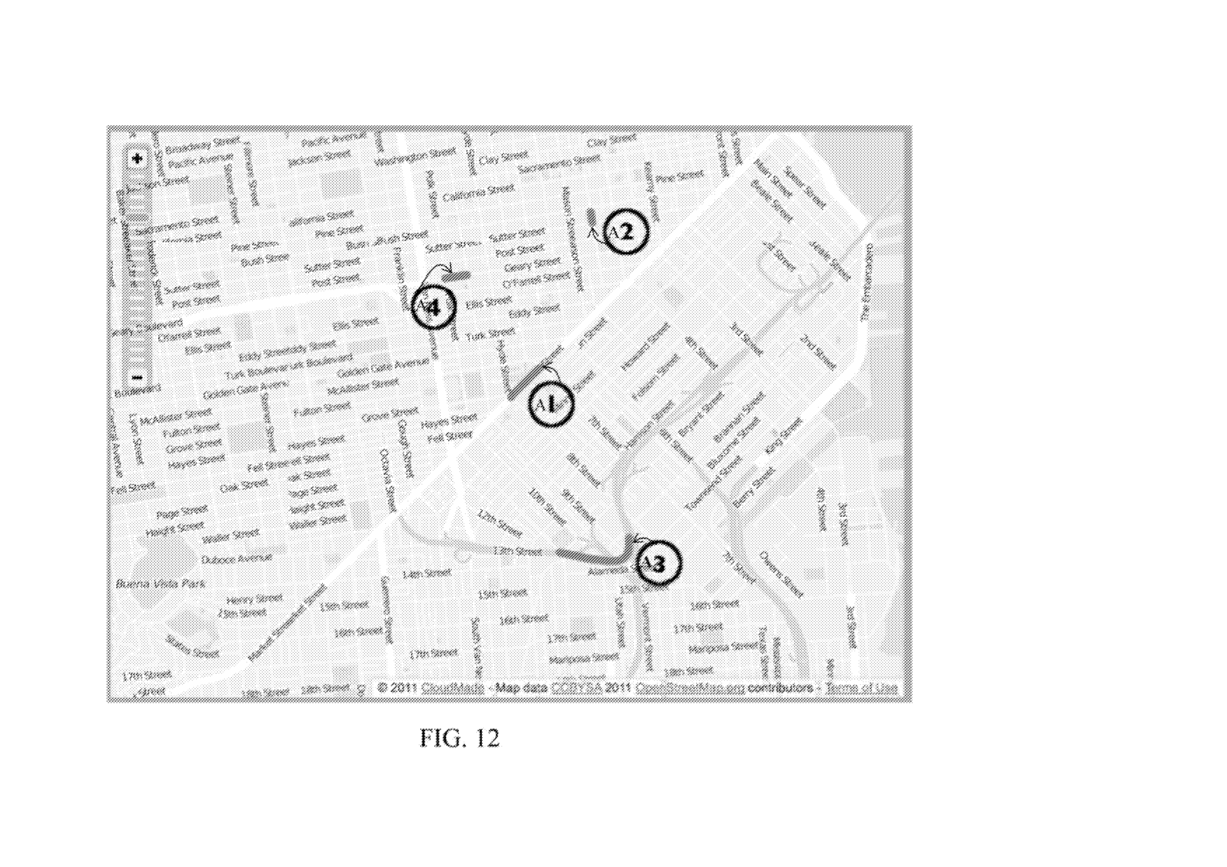

FIG. 12 represents a portion of a route planning map for San Francisco, Calif. identifying segments to be avoided, as denoted A1, A2, A3, and A4, as detected by using the algorithm of an embodiment used at least in part for generating the optimized planning digital map.

### Experimental Results and Examples Set Nos. 4-7

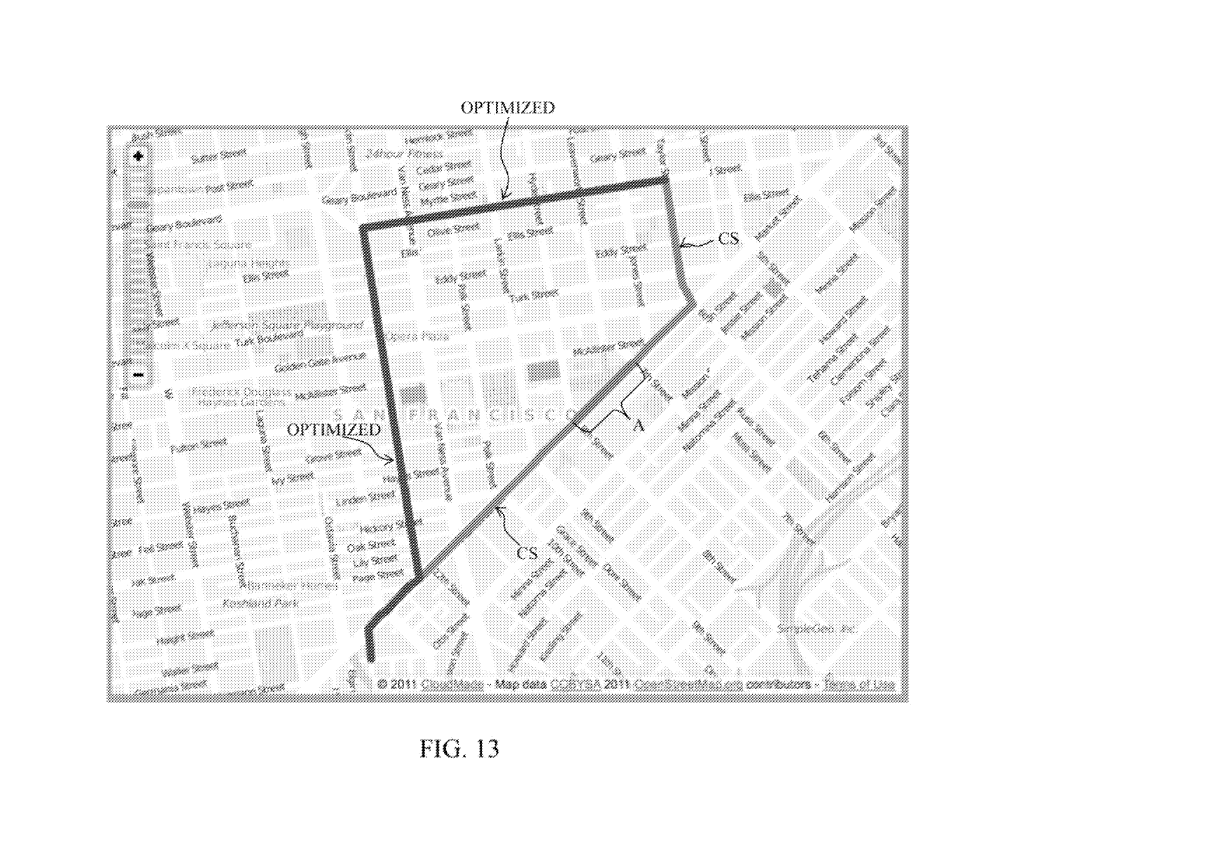

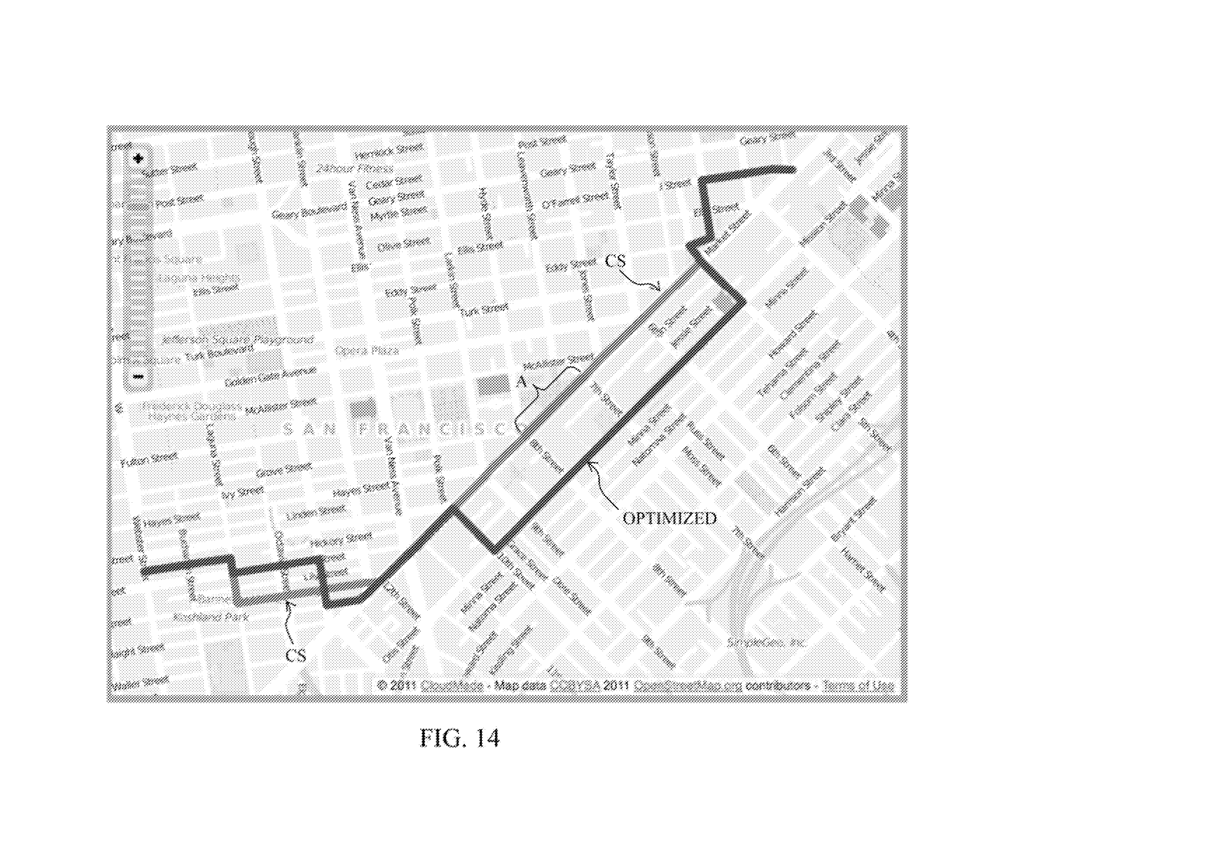

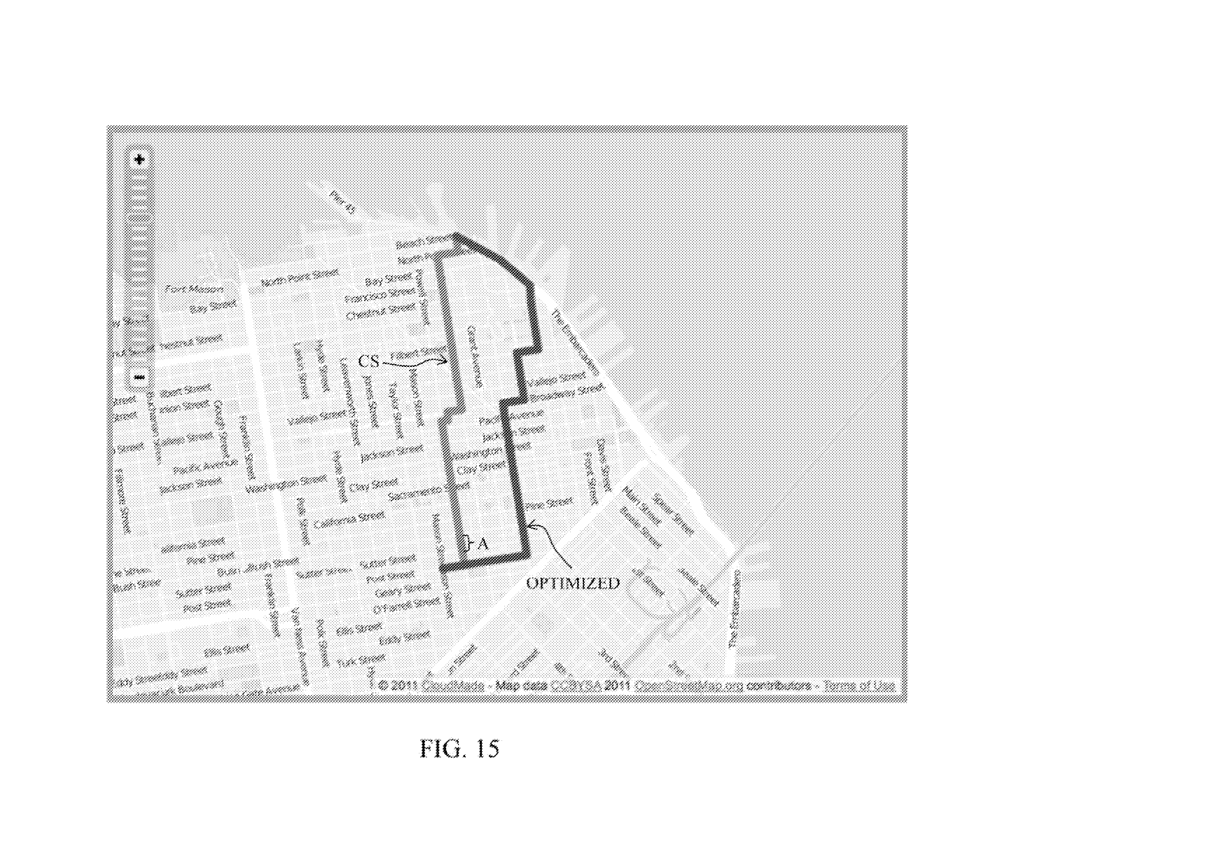

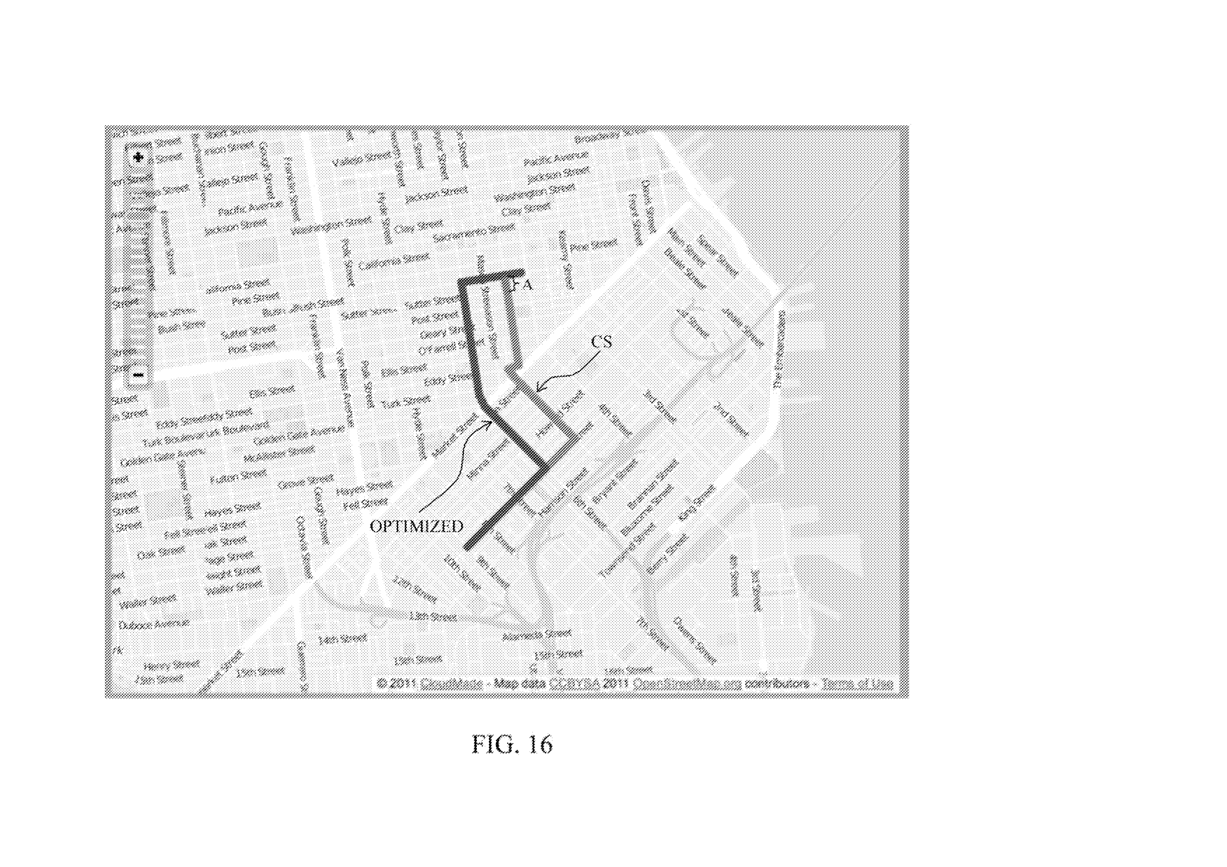

FIGS. 13-16 each represents a route planning map for San Francisco, Calif. generated by the use of an embodiment of the present invention digital map optimization system or method, which provides a comparison to the generated conventional suggested route, CS. The map illustrates the optimized route whereby the optimized route is not necessarily the route having the greatest speed limit or shortest distance, for example, but rather the most preferred route based on the algorithm of an embodiment generating the optimum route planning digital map.

The devices, systems, compositions, computer program products, and methods of various embodiments of the invention disclosed herein may utilize aspects disclosed in the following references, applications, publications and patents and which are hereby incorporated by reference herein in their entirety:

1. U.S. Patent Application Publication No. US 2008/0033633 A1, Akiyoshi, et al., “Guide Route Search Device and Guide Route Search Method”, Feb. 7, 2008; U.S. patent application Ser. No. 10/574,k1015, filed Oct. 19, 2006.

2. U.S. Pat. No. 7,062,376 B2, Oesterling, “Method and System For Providing A Carpool Service Using A Telematics System”, Jun. 13, 2006.

3. U.S. Pat. No. 7,577,244 B2, Taschereau, “Method and System For Providing Geographically Targeted Information and Advertising”, Aug. 18, 2009.

4. U.S. Pat. No. 7,225,076 B2, Sugawara, “Map Search System”, May 29, 2007.

5. U.S. Pat. No. 5,177,685, Davis, et al., “Automobile Navigation System Using Real Time Spoken Driving Instructions”, Jan. 5, 1993.

6. U.S. Patent Application Publication No. US 2008/0172172 A1, NG, “Route Planning Process”, Jul. 17, 2008; U.S. patent application Ser. No. 12/004,516, filed Dec. 21, 2007.

7. European Patent Application Publication No. EP 0 317 181 B1, Tarrant, “Road Vehicle Route Selection and Guidance Systems”, Jan. 19, 1994; EP Patent Application Serial No. 88310624.7, filed Nov. 10, 1988.

8. U.S. Application Publication No. US 2009/0175172 A1, Prytz, et al., “Method and Arrangement for Route Cost Determination and Selection with Link Cost Interaction”, Jul. 9, 2009; U.S. patent application Ser. No. 11/917,112, filed May 30, 2008.

9. U.S. Pat. No. 6,633,812 B1, Martin, et al., “Method For Influencing Source Date For Determining A Route in A Navigation System”, Oct. 14, 2003.

10. U.S. Patent Application Publication No. US 2008/0270019 A1, Anderson, et al., “Systems and Methods for Enhancing Private Transportation”, Oct. 30, 2008; U.S. patent application Ser. No. 12/005,845, filed Dec. 28, 2007.

11. U.S. Pat. No. 7,577,108 B2, Zhang, et al., “Learning-Based Strategies For Message-Initiated Constraint-Based Routing”, Aug. 18, 2009.

12. U.S. Patent Application Publication No. US 2009/0271104 A1, Letchner, et al., “Collaborative Route Planning For Generating Personalized and Context-Sensitive Routing Recommendations”, Oct. 29, 2009; U.S. patent application Ser. No. 12/466,308, filed May 14, 2009.

13. U.S. Pat. No. 7,610,151 B2, Letchner, et al., “Collaborative Route Planning For Generating Personalized and Context-Sensitive Routing Recommendations”, Oct. 27, 2009.

14. Google Map Maker

15. U.S. Patent Application Publication No. US 2010/0131186 A1, Geelen, et al., “Method of Generating Improved Map Data For Use in Navigation Devices, Map Data and Navigation Device Therefore”, May 27, 2010; U.S. patent application Ser. No. 12/310,102, filed Jan. 25, 2010.

16. U.S. Patent Application Publication No. US 2010/0131189 A1, Geelen, et al., “Method of Generating Improved Map Data for Use in Navigation Devices and Navigation Device With Improved Map Data”, May 27, 2010; U.S. patent application Ser. No. 12/310,064, filed Jan. 25, 2010.

17. U.S. Patent Application Publication No. US 2008/0082225 A1, Barrett, “A Method of Reporting Errors in Map Data Used by Navigation Devices”; U.S. patent application Ser. No. 11/464,609, filed Aug. 15, 2006.

18. International Patent Application Publication No. WO 2008/019885 A1, Geelen, et al., “A Method of Generating Improved Map Data For Use in Navigation Devices”, Feb. 21, 2008; International Patent Application Serial No. PCT/EP2007/007311, filed Aug. 15, 2007.

In summary, while the present invention has been described with respect to specific embodiments, many modifications, variations, alterations, substitutions, and equivalents will be apparent to those skilled in the art. The present invention is not to be limited in scope by the specific embodiment described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particularly interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

We claim:

1. A system for determining an optimum route planning digital map to be applied onto a first route planning digital map, said system comprising:
a) a memory component operative to store:
said first route planning digital map comprises a collection of nodes and arcs, wherein an arc is defined as a segment between a pair of nodes, and
preferred route data, said preferred route data comprises a collection of arcs representing a collection of routes that an entity finds preferable with respect to some unquantified criterion; and
b) a processor in communication with said memory component configured to:
assign arc costs to said arc, wherein said assigned arc cost is determined by synthesizing said preferred route data together with a distribution over baseline arc costs,
apply said assigned arc costs to said first route planning digital map to provide an optimized route planning digital map, and
perform at least one of:
storing said optimized route planning digital map for use; or
communicating said optimized route planning digital map for use with an output device or other processor based system.

2. The system of claim 1, wherein said entity comprises at least one of: individual, individuals, and specialized user.

3. The system of claim 1, wherein said arc costs comprises at least one penalty.

4. The system of claim 1, wherein said arc costs comprises at least one road segment avoidance.

5. The system of claim 1, wherein said arc costs comprises at least one of: an event, an episode, and weather condition.

6. The system of claim 1, wherein said arc costs comprises at least one of: travel time, safety, speed limit, congestion, distance, road width, road conditions, and terrain.

7. The system of claim 1, wherein said arc costs comprises at least one of: travel time, safety, speed limit, congestion, road segment avoidance, road-absence activity, distance, penalties, road width, road conditions, weather, event, episode, and terrain.

8. The system of claim 1, wherein said arc costs comprises at least one road-absence activity.

9. The system of claim 1, wherein said synthesizing is performed by inferring arc costs using a probabilistic model.

10. The system of claim 9, wherein said probabilistic model is a Bayesian model.

11. The system of claim 9, wherein said inferred arc costs are chosen by deriving estimates from said probabilistic model.

12. The system of claim 10, wherein said inferred arc costs are chosen as maximum a-posteriori probability (MAP) estimates.

13. The system of claim 12, wherein said MAP estimates of said inferred arc costs are computed using sequential unconstrained minimization technique.

14. The system of claim 1, wherein said preferred route data is received from a source including at least one of: manual communication entry, GPS communication, internet communication, or memory storage of preferred route data.

15. The system of claim 1, wherein said preferred route data is received from a source including at least one of: triangulation system, accelerometer system, transponder system, radio frequency system, blue tooth communication system, RFID system, or gyro system.

16. The system of claim 1, wherein assigned arc costs are updated in real-time.

17. The system of claim 1, wherein said receiving at least part of said preferred route data is effected in real time.

18. The system of claim 17, wherein said assigned arc costs are updated in real time.

19. The system of claim 1, wherein said optimized route planning digital map to be utilized for at least one of: commercial or personal transportation, parcel delivery, taxi or limousine service, military logistics and transportation, emergency medical services (EMS), disaster response, shipping logistics, and evacuation route planning.

20. The system of claim 1, wherein said optimized route planning digital map to be utilized for at least one of: route guidance, multi-modal transportation system monitoring, location-based consumer applications, and vehicle fleet administration.

21. The system of claim 1, wherein said output device comprises at least one of the following: monitor, printer, speaker, or display.

22. The system of claim 1, wherein said processor based system comprises at least one of: computer, remote computer, networked computers, servers, PDAs, PCs, tracking module, workstation, microprocessor based appliance, and navigation system.

23. The system of claim 1, wherein said synthesizing comprises:
assigning prior distributions to said arc costs in said first route planning digital map.

24. The system of claim 23, wherein said synthesizing comprises:
assigning a distribution to error terms on said arcs in each route preference pair.

25. The system of claim 24, wherein said synthesizing comprises:
constructing likelihood functions characterizing the probability of observing each route preference.

26. The system of claim 25, wherein said synthesizing comprises:
combining prior distributions and likelihoods to determine updated arc costs.

27. A computer implemented method for determining an optimum route planning digital map, said method comprising:
providing for receiving a first route planning digital map data, said first route planning digital map data comprises a collection of nodes and arcs, wherein an arc is defined as a segment between a pair of nodes,
providing for receiving preferred route data, said preferred route data comprises a collection of arcs representing a collection of routes that an entity finds preferable with respect to some unquantified criterion;
providing for assigning arc costs to said arc, wherein said assigned arc cost is determined by synthesizing said preferred route data together with a distribution over baseline arc costs;
providing for applying said assigned arc costs to said first route planning digital map to provide an optimized route planning digital map; and
providing for communicating said optimized planning digital map for storage or output.

28. The method of claim 27, wherein said entity comprises at least one of: individual, individuals, and specialized user.

29. The method of claim 27, wherein said arc costs comprises at least one penalty.

30. The method of claim 27, wherein said arc costs comprises at least one road segment avoidance.

31. The method of claim 27, wherein said arc costs comprises at least one of: an event, an episode, and weather condition.

32. The method of claim 27, wherein said arc costs comprises at least one of: travel time, safety, speed limit, congestion, distance, road width, road conditions, and terrain.

33. The method of claim 27, wherein said arc costs comprises at least one of: travel time, safety, speed limit, congestion, road segment avoidance, road-absence activity, distance, penalties, road width, road conditions, weather, event, episode, and terrain.

34. The method of claim 27, wherein said arc costs comprises at least one road-absence activity.

35. The method of claim 27, wherein said synthesizing is performed by inferring arc costs using a probabilistic model.

36. The method of claim 35, wherein said probabilistic model is a Bayesian model.

37. The method of claim 35, wherein said inferred arc costs are chosen by deriving estimates from said probabilistic model.

38. The method of claim 36, wherein said inferred arc costs are chosen as maximum a-posteriori probability (MAP) estimates.

39. The method of claim 38, wherein said MAP estimates of said inferred arc costs are computed using sequential unconstrained minimization technique.

40. The method of claim 27, wherein said preferred route data is received from a source including at least one of: manual communication entry, GPS communication, internet communication, or memory storage of preferred route data.

41. The method of claim 27, wherein said preferred route data is received from a source including at least one of: triangulation system, accelerometer system, transponder system, radio frequency system, blue tooth communication system, RFID system, or gyro system.

42. The method of claim 27, wherein assigned arc costs are updated in real-time.

43. The method of claim 27, wherein said receiving at least part of said preferred route data is effected in real time.

44. The method of claim 43, wherein said assigned arc costs are updated in real time.

45. The method of claim 27, wherein said optimized route planning digital map to be utilized for at least one of: commercial or personal transportation, parcel delivery, taxi or limousine service, military logistics and transportation, emergency medical services (EMS), disaster response, shipping logistics, and evacuation route planning.

46. The method of claim 27, wherein said optimized route planning digital map to be utilized for at least one of: route guidance, multi-modal transportation system monitoring, location-based consumer applications, and vehicle fleet administration.

47. The method of claim 27, wherein said output device comprises at least one of the following: monitor, printer, speaker, or display.

48. The method of claim 27, wherein said processor based system comprises at least one of: computer, remote computer, networked computers, servers, PDAs, PCs, tracking module, workstation, microprocessor based appliance, and navigation system.

49. The method of claim 27, wherein said synthesizing comprises:
assigning prior distributions to said arc costs in said first route planning digital map.

50. The method of claim 49, wherein said synthesizing comprises:
assigning a distribution to error terms on said arcs in each route preference pair.

51. The method of claim 50, wherein said synthesizing comprises:
constructing likelihood functions characterizing the probability of observing each route preference.

52. The method of claim 51, wherein said synthesizing comprises:
combining prior distributions and likelihoods to determine updated arc costs.

53. A computer program product comprising a non-transitory computer useable medium having a computer program logic for enabling a computer system for determining an optimum route planning digital map, said computer logic comprising:
receiving a first route planning digital map data, said first route planning digital map data comprises a collection of nodes and arcs, wherein an arc is defined as a segment between a pair of nodes,
receiving preferred route data, said preferred route data comprises a collection of arcs representing a collection of routes that an entity finds preferable with respect to some unquantified criterion;
assigning arc costs to said arc, wherein said assigned arc cost is determined by synthesizing said preferred route data together with a distribution over baseline arc costs;
applying said assigned arc costs to said first route planning digital map to provide an optimized route planning digital map; and
communicating said optimized planning digital map for storage or output.

54. A server computer system, said server computer system comprising:
a memory component operative to receive and store data representing an optimized route planning digital map; and
a processor in communication with said memory component configured to execute said optimized route planning digital map, wherein said optimized route planning digital map was produced by the following steps:
receiving a first route planning digital map data, said first route planning digital map data comprises a collection of nodes and arcs, wherein an arc is defined as a segment between a pair of nodes,
receiving preferred route data, said preferred route data comprises a collection of arcs representing a collection of routes that an entity finds preferable with respect to some unquantified criterion,
assigning arc costs to said arc, wherein said assigned arc cost is determined by synthesizing said preferred route data together with a distribution over baseline arc costs, and
applying said assigned arc costs to said first route planning digital map to generate said optimized route planning digital map.

55. The server computer system of claim 54, wherein said server computer system is a navigation system server.

56. A navigation system for use with a server computer system, said navigation system comprising:
a memory component operative to receive data from said server computer system, and store data representing an optimized route planning digital map; and
a processor in communication with said memory component configured to execute said optimized route planning digital map, wherein said optimized route planning digital map was produced by the following steps:
receiving a first route planning digital map data, said first route planning digital map data comprises a collection of nodes and arcs, wherein an arc is defined as a segment between a pair of nodes,
receiving preferred route data, said preferred route data comprises a collection of arcs representing a collection of routes that an entity finds preferable with respect to some unquantified criterion;
assigning arc costs to said arc, wherein said assigned arc cost is determined by synthesizing said preferred route data together with a distribution over baseline arc costs, and
applying said assigned arc costs to said first route planning digital map to generate said optimized route planning digital map.

57. The navigation system of claim 56, wherein said navigation system comprises at least one of: GPS system, PDA, computer, mobile phone, or internet-enabled device.

58. A system for determining an optimum route planning digital map to be applied onto a first route planning digital map, said system comprising:
means for receiving a first route planning digital map data, said first route planning digital map data comprises a collection of nodes and arcs, wherein an arc is defined as a segment between a pair of nodes,
means for receiving preferred route data, said preferred route data comprises a collection of arcs representing a collection of routes that an entity finds preferable with respect to some unquantified criterion;
means for assigning arc costs to said arc, wherein said assigned arc cost is determined by synthesizing said preferred route data together with a distribution over baseline arc costs;
means for applying said assigned arc costs to said first route planning digital map to provide an optimized route planning digital map; and
means for communicating said optimized planning digital map for storage or output.

59. The computer program product of claim 53, wherein said computer logic is configured to perform the steps included in any one of claims 28-52.
